(19) United States
(12) Patent Application Publication
(10) Pub. No.: US 2005/0058471 A1
(43) Pub. Date: Mar. 17, 2005

(54) Developer container and image forming apparatus

(75) Inventors: Hitoshi Nagahama, Uji-shi (JP); Masanobu Deguchi, Kashiba-shi (JP); Kazuya Koyama, Ikoma-shi (JP); Shigeki Hayashi, Ikoma-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 10/925,950

(22) Filed: Aug. 26, 2004

(30) Foreign Application Priority Data
Aug. 29, 2003 (JP) 2003-307802

(51) Int. Cl. G03G 15/08

(52) U.S. Cl. 399/262

(57) ABSTRACT

A developer container of the present invention includes a container main body and a supporting member. The container main body is used to contain a developer. The supporting member supports the container main body in such a manner that the container main body is freely rotatable. Further, the container main body includes (i) a first container portion, (ii) a second container portion, and (iii) a third container portion. The third container portion includes a first and a second recess portion on its outer peripheral surface. The first recess portion is inwardly depressed in a radial direction of the third container portion. The second recess portion is so provided that the second recess portion is located oppositely to the first recess portion with respect to an axis line of the third container portion. In the first recess portion, a discharging opening is provided in the first recess portion so as to discharge the developer in a rotation direction in which the container main body rotates around the axis line. Further, a regulating member having a tube-like shape is provided so that the regulating member surrounds the discharging opening. The regulating member regulates a discharging amount of the developer. This allows the developer to be always evenly supplied.

This Nonprovisional application claims priority under 35 U.S.C. § 119(a) on Patent Application No. 2003/307802 filed in Japan on Aug. 29, 2003, the entire contents of which are hereby incorporated by reference.

### FIELD OF THE INVENTION

The present invention relates to a developer container for containing a developer, such as a toner, for an electro-photographical image forming, and to an image forming apparatus in which the developer container is detachably provided.

### BACKGROUND OF THE INVENTION

An image forming apparatus—such as a photocopier, a printer, and a facsimile—uses a developer, such as a toner, to develop an image. Generally, in such an image forming apparatus, a developer container such as a toner cartridge is provided. The develop container contains (stores) the developer, and supplies the developer to a developing section of the image forming apparatus during development.

Incidentally, in recent years, there has been a demand for an image forming apparatus which can print a large amount of documents at high speed. For example, there is an image forming apparatus of fast printing type (the type that can form images on 50 or greater sheets of paper for one minute) that can handle 999 sheets at a time. Further, the image forming apparatus occasionally carries out a continuous printing for over 999 sheets, depending on a setting of the printing. Therefore, such a fast image forming apparatus needs a toner cartridge that can contain a large amount of toner, and some toner cartridge can contain, for example, approximately 1400 g of toner.

Disclosed in Japanese Laid-Open Patent Application Tokukaihei 08-339115/1996 (published on Dec. 24, 1996; hereinafter, referred to as “Reference 1”) is a specific example of a toner cartridge (supplying developer container) that can contain a large amount of toner. FIG. 25 is a perspective view illustrating the supplying developer container 20 described in Reference 1. The supplying developer container 20 has a cylindrical shape whose ends are closed, and has a containing space for toner. The supplying developer container 20 includes supplying means (first protruding ledge) 21a, and supplying means (second protruding ledge) 21b. The supplying means 21a inwardly protrudes in a radial direction of the supplying developer container 20, and spirally extends, from a first end portion 20a of the supplying developer container 20 to a central portion 20c of the supplying developer container 20, with respect to an axis line L20, the first end portion 20a being one end in the axis line L20, and the central portion being in a center of the axis line L20. Meanwhile, the supplying means 21b inwardly protrudes in the radial direction of the supplying developer container 20, and spirally extends, from its second end portion 20b to its central portion 20c, with respect to the axis line L20, the second end portion being the other end in the axis L20. In the central portion 20c of the supplying developer container 20, an outlet hole 22 is formed. The outlet hole 22 penetrates the supplying developer container 20, and connects the containing space to an outside of the supplying developer container 20.

The supplying developer container 20 is coupled with an image forming apparatus main body (not shown) so that the axis line L20 is parallel to a horizontal direction, and that the central portion 20c is positionally associated with a toner supplying hole which is provided in the image forming apparatus main body, the toner supplying hole being open upward. The supplying developer container 20 is driven, to rotate around the axis line L20, by a driving section provided on the image forming apparatus main body. By doing this, the toner contained in the containing space is sent to the central portion 20c by the supplying means 21a and 21b. When the outlet hole 22 comes to a position to face the toner supplying hole, the toner is supplied, via the outlet hole 22, to the toner supplying hole.

As described above, the supplying developer container 20 of Reference 1 contains toner, and rotates to supply the toner to the outlet hole 22 by the supplying means 21a and 21b, both of which extend to the outlet hole 22. Thereafter, the developer thus supplied is discharged from the outlet hole 22, thereby supplying the developer to a developing apparatus (not shown) provided in the image forming apparatus. Therefore, if the supplying toner container 20 is provided in the image forming apparatus so that the outlet hole 22 can be disposed above the toner supplying hole which supplies the toner to the developing apparatus, a space that is not efficiently used is reduced. Accordingly, the supplying developer container 20 can contain larger amount of toner.

However, it is difficult to attain a complete seal between the image forming apparatus main body and the central portion 20c that rotates. Accordingly, when the supplying developer container 20 rotates, the toner possibly leaks from a space between the central portion and the image forming apparatus main body, and possibly flies over inside the image forming apparatus main body.

Further, a toner is a fine particle having a particle diameter of 4 μm to 10 μm, and is highly flowable. Therefore, in cases where the rotation of the supplying developer container 20 is stopped when the outlet hole 22 faces the toner supplying hole, a large amount of toner possibly flows into the toner supplying hole via the outlet hole 22. When the toner is too much supplied from the toner supplying hole to the developing section, a toner density in the developing apparatus is increased at the time of the oversupply. This possibly causes images to be unevenly developed.

Further, under the supplying developer container 20, the developing apparatus is provided. Therefore, due to a load (i.e. weight of the toner) imposed on the toner, the toner flows into the developing apparatus via the outlet hole 22. Accordingly, depending on the load imposed on the toner (i.e., amount of toner left in the supplying developer container 20), an amount of the toner to be supplied is varied. This leads to unstable supply of the toner to the developing apparatus.

Specifically, when a large amount of the toner is contained in the supplying developer container 20, a heavy load is imposed on the toner, thereby increasing the amount of the toner to be supplied to the developing apparatus due to its weight. Further, in this case, the toner is so densed due to pressure caused by its weight, and amount of the toner per unit volume becomes so large. As a result, the amount of the toner to be supplied is further increased. However, as the toner in the supplying developer container 20 decreases, the load imposed on the toner (i.e. the weight of the toner) decreases. This decreases the amount of the toner to be supplied to the developing apparatus. Further, because the toner becomes less densed, and the amount of the toner per volume is reduced, the amount of the toner to be supplied is further reduced.

The supplying developer container 20 described in Reference 1 has such a problem that the amount of the toner to be supplied depends on the amount of the toner contained in the supplying developer container 20, and that the toner is therefore unstably supplied. When the toner is thus unstably supplied, images are not always evenly developed, thereby deteriorating image qualities. Further, when the amount of the toner remained in the supplying developer container 20 is small, the toner cannot be securely supplied to the developing apparatus. A sensor, which detects how much toner is left, would possibly misunderstand that there is no toner left in the supplying developer container 20, and accordingly causes to display a message advising to change the supplying developer container (toner cartridge), even when the toner is still left in the supplying developer container 20, the sensor being provided in a hopper of the developing apparatus, or the like.

### SUMMARY OF THE INVENTION

The present invention is made in view of the foregoing conventional problems, and an object thereof is to provide a developer container, with which a toner is always evenly supplied to a developing section of an image forming apparatus, irrespective of an amount (particularly, weight of the toner) of the toner contained in the developer container.

To solve the problem, a developer container of the present invention includes: (1) a container main body, configured to be detachably provided in an image forming apparatus, and to contain a developer for use in image formation, the container main body having a cylindrical shape; and (2) a supporting member which supports the container main body in such a manner that the container main body is freely rotatable, wherein: (i) the container main body has a recess portion on its outer peripheral surface, the recess portion being inwardly depressed in a radial direction of the container main body, having a discharging opening so as to discharge the developer in a downstream of a rotation direction in which the container main body rotates around an axis line of the container main body; (ii) the developer contained in the container main body is sent to the discharging opening by rotating the container main body around the axis line; (iii) the supporting member supports the container main body by wholly covering at least that portion of the container main body which includes the recess portion of the container main body in such a manner that the container main body is freely rotatable with respect to the axis line; (iv) the container main body includes a through opening for leading the developer to an outside of the container main body, the developer being discharged from the discharging opening; and (v) a regulating member for regulating a discharging amount of the developer is provided, substantially along the rotation direction of the container main body, on that surface of the recess portion which the discharging opening is provided.

As described above, the developer container of the present invention includes the container main body and the supporting member, and the regulating member is provided substantially along the rotation direction of the container main body so as to regulate the discharging amount of the developer. This prevents the self weight-induced flow-in of the developer when the developer is supplied to the recess portion via the discharging opening. Namely, the regulating member diverts the flow path of the developer that is to pass through the discharging opening, and a resisting force is exerted against the load of the gravity of the developer. This prevents the self weight-induced flow-in of the developer, i.e., prevents the developer from directly flowing into the recess portion. Accordingly, even when a good deal of the developer is contained in the container main body, the self weight-induced flow-in is prevented from causing a large amount of the developer to the recess portion. Therefore, the regulating member ensures that the developer is evenly supplied from the developer container to the developing section irrespective of how much developer is left in the developer container. This can improve an image quality during the image forming.

Further, the image forming apparatus of the present invention includes: (i) a developer container, configured to be detachably provided to contain a developer for use in an image formation; and (ii) a developing section for developing an image with the use of the developer supplied from the developer container.

According to the arrangement, the developer container allows the developer to be stably supplied to the developing section, irrespective of how much the developer is left in the developer container. This prevents blocking and puncturing due to the agglomeration of the developer. On this account, an image quality can be improved.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a perspective view illustrating a third container portion of a developer container of one embodiment of the present invention.

FIG. 2 is a perspective view illustrating the developer container of one embodiment of the present invention.

FIG. 3 is a front view illustrating the developer container shown in FIG. 2.

FIG. 4 is a left side view illustrating the developer container shown in FIG. 2.

FIG. 5 is a front view illustrating a container main body of the developer container shown in FIG. 2.

FIG. 6(a) is a left side view illustrating the container main body shown in FIG. 5. FIG. 6(b) is a right side view illustrating the container main body shown in FIG. 5.

FIG. 7(a) is a perspective view illustrating a third container portion that does not include a regulating member. FIG. 7(b) is a perspective view illustrating a third container portion of another embodiment of the present invention.

FIG. 8 is an enlarged front view illustrating a vicinity of the third container portion of the developer container shown in FIG. 2.

FIG. 9(a) is a cross sectional view illustrating the third container portion (shown in FIG. 1), which is taken along a line S91-S91 of FIG. 8. FIG. 9(b) is a cross sectional view illustrating the third container portion (shown in FIG. 1), which is taken along a line S92-S92 of FIG. 8.

FIG. 10 is a front view illustrating a supporting member of the developer container (shown in FIG. 2).

FIG. 11 is a right side view illustrating the supporting member of FIG. 10.

FIG. 12 is an exploded right side view illustrating the supporting member of FIG. 10.

FIG. 13 is a cross sectional view illustrating the supporting member (shown in FIG. 10), which is taken along a line S13-S13 of FIG. 11.

FIG. 14(a) is a front view illustrating a sealing member for sealing between the container main body and the supporting member. FIG. 14(b) is a cross sectional view illustrating the sealing member taken perpendicular to its outer peripheral surface.

FIG. 15 is a front view illustrates an assembly of the developer container of FIG. 2.

FIG. 16 is a cross sectional view illustrating the developer container (shown in FIG. 15), which is taken along a line S16-S16 of FIG. 15.

FIG. 17 is a cross sectional view illustrating the developer container (shown in FIG. 4), which is taken along a line S17-S17.

FIG. 18 is a cross sectional view illustrating the developer container (shown in FIG. 3), which is taken along a line S18-S18.

FIG. 19(a) and FIG. 19(b) are an enlarged view illustrating an IXX parts (shown in FIG. 18).

FIG. 20(a) and FIG. 20(b) are explanatory views illustrating, in the developer container (shown in FIG. 2), how the developer contained in the third container portion of the container main body is led to a through opening of the supporting member, when the container main body rotates around an axis line L31 in a rotation direction R.

FIG. 21(a) and FIG. 21(b) are explanatory views how, after the operation shown in FIG. 20(a) and FIG. 20(b), the developer contained in the third container portion of the container main body is led to a through opening of the supporting member.

FIG. 22(a) and FIG. 22(b) illustrates how a regulating member, provided in the third container portion of the developer container of the present invention, is formed by carrying out a blow forming.

FIG. 23 is a cross sectional view illustrating an image forming apparatus of one embodiment of the present invention.

FIG. 24(a) is a schematic diagram illustrating a flow of a toner in a third container portion that does not include the regulating member. FIG. 24(b) is a schematic diagram illustrating a flow of a toner in a third container portion that includes the regulating member.

FIG. 25 is a perspective view illustrating a conventional developer container.

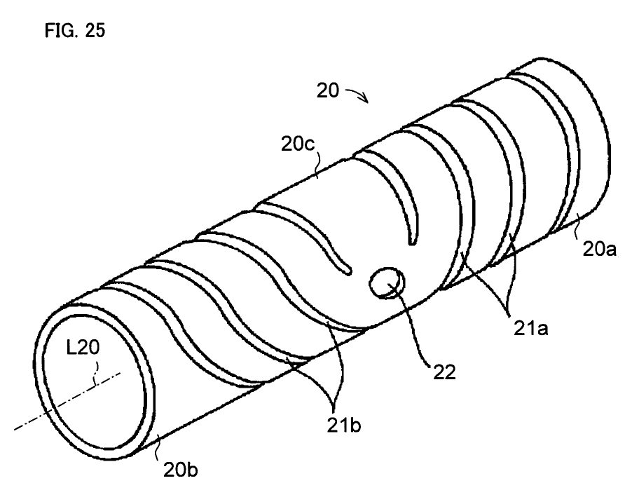

### DESCRIPTION OF THE EMBODIMENTS

The following description deals with one embodiment of the present invention, however, the present invention is not limited to this. The present embodiment exemplifies a developer container such as a toner cartridge, the developer container being detachably provided in an image forming apparatus of electro-photographical type.

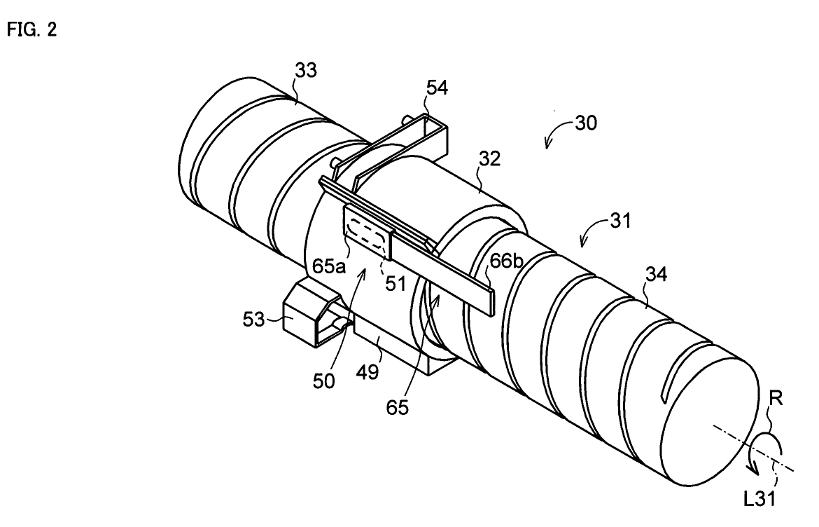

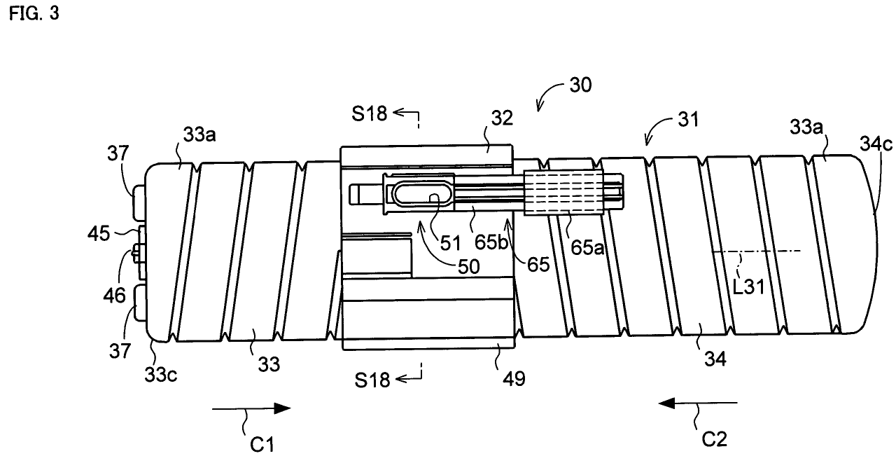

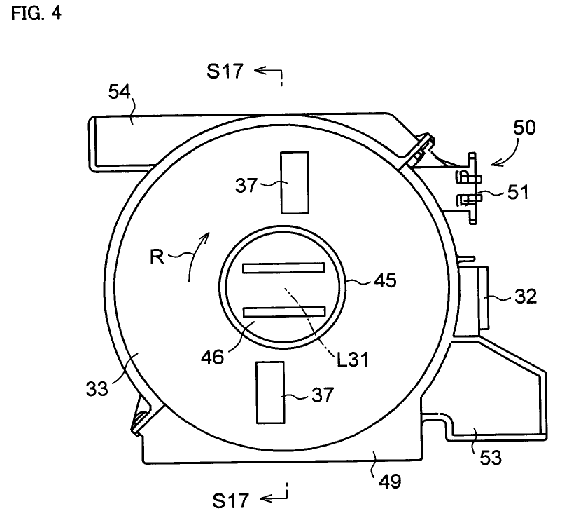

FIG. 2 is a perspective view illustrating a developer container 30 of one embodiment of the present invention. FIG. 3 is a front view illustrating the developer container 30. FIG. 4 is a left side view illustrating the developer container 30. The developer container 30 includes a container main body 31 and a supporting member 32. The container main body 31 has a substantially cylindrical shape, and is used for containing a developer, such as toner, for an electro-photographical image forming. The supporting member 32 supports the container main body 31 so that the container main body 31 can rotate with respect to an axis line L31 of the container main body 31. The developer container 30 can contain, for example, 1400 g of developer. Note that, hereinafter, the axis line L31 of the container main body 31 is also described as “rotation axis line L31.”

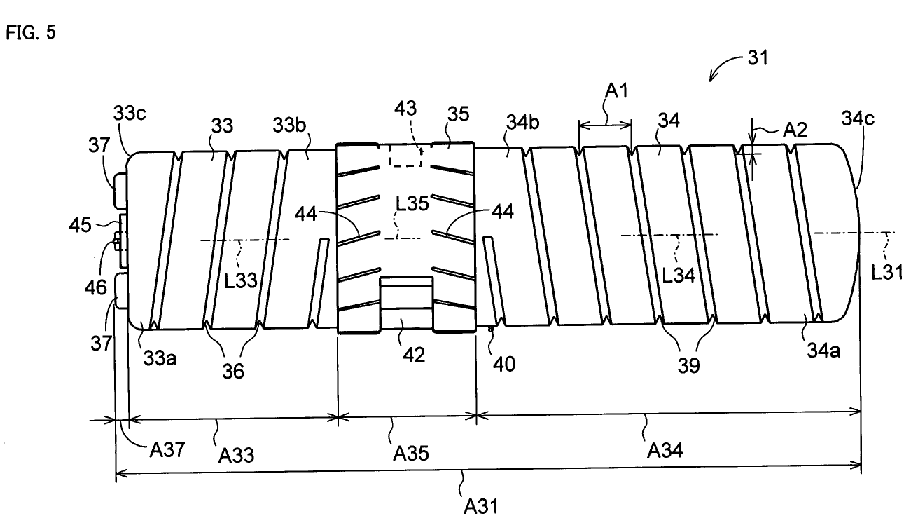

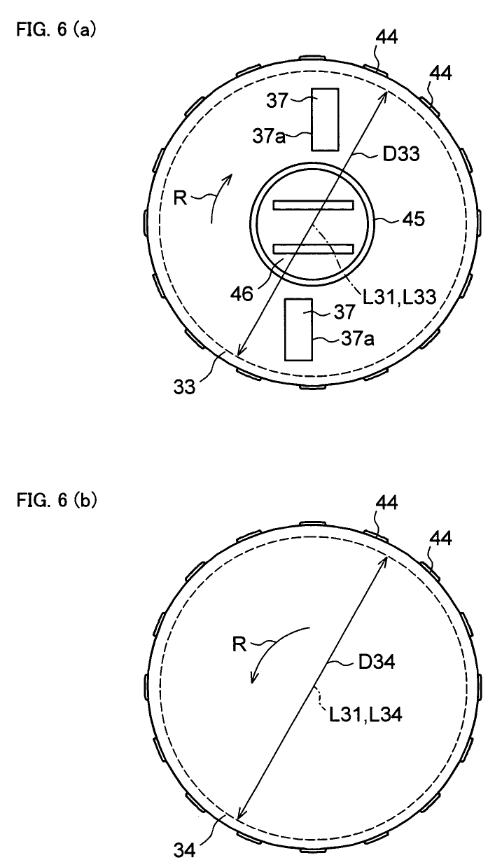

FIG. 5 is a front view illustrating the container main body 31. FIG. 6(a) is a left side view illustrating the container main body 31. FIG. 6(b) is a right side view illustrating the container main body 31. The container main body 31 includes a first container portion 33, a second container portion 34, and a third container portion 35. The container main body 31 may have a length A31 of, for example, 200 mm to 550 mm along the axis line L31.

The first container portion 33 has a cylindrical shape having a bottom. The first container portion 33 may have a length A33 of, for example, 50 mm to 250 mm along an axis line L33. As shown in FIG. 5, the first container 33 has a first protruding ledge 36 in its inner peripheral surface. The first protruding ledge 36 inwardly protrudes in a radial direction of the first container portion 33, and spirally extends from a bottom portion 33a to an aperture end portion 33b, the bottom portion 33a being a first end portion of the first container portion 33 in the axis line L33, and the aperture end portion 33b being a second end portion of the first container portion 33 in the axis line L33. Specifically, when seen from the bottom portion 33a of the first container portion 33, the first protruding ledge 36 spirally extends from the bottom portion 33a to the aperture end portion 33b so that the first protruding ledge 36 rotates counterclockwise, along the inner peripheral surface of the first container portion 33, with respect to the axis line L33.

As shown in FIG. 5 and FIG. 6(a), on the bottom portion 33a, a plurality of (two in the present embodiment) fit-in rise portions 37 and a refill opening 45 are provided. The fit-in rise portions 37 outwardly protrude from the bottom portion 33a in a direction from the aperture end portion 33b to the bottom portion 33a, and serves as connecting portions. The refill opening 45 is formed on a central portion of the bottom portion 33a of the first container portion 33, and penetrates the bottom portion 33a in a direction along the rotation axis line L 31. The refill opening 45 has a circular shape whose center is coincident with the axis line L33 of the first container portion 33. The refill opening 45 is sealed by a detachable refill cover 46 in such a manner that the refill cover 46 is not detached by a rotation of the container main body 31. The refill cover 46 has a shape that corresponds to the shape of the refill opening 45. When the refill cover 46 is detached from the refill opening 45, an inside of the container main body 31 is connected to an outside thereof, thereby allowing the container main body 31 to be refilled with a developer.

Specifically, the fit-in rise portions 37 are symmetrically provided and positioned outwardly from the refill opening 45 in the radial direction of the first container portion 33, with respect to the axis line L33 of the first container portion 33. More specifically, as shown in FIG. 6(a), the fit-in rise portions 37 each have upstream side surfaces 37a, which is formed in upstream of a rotation direction R. The rotation direction R is a clockwise rotation direction with respect to the rotation axis line L31 when seen from the bottom portion 33a of the first container portion 33. The upstream side surfaces 37a are flat surfaces that extend perpendicularly to the rotation direction R, respectively. Further, the fit-in rise portions 37 have slopes that decline, in the direction of the second end portion, from the upstream side surfaces 37a to their downstream side surfaces, respectively. The fit-in rise portions 37 may each have a protruding amount A37 of, for example, 5 mm to 20 mm from the bottom portion 33a in the direction along the axis line L33. The fit-in rise portions 37 are detachably attached to a main body connecting portion (not shown) of an image forming apparatus 70 (described later).

The bottom portion 33a of the first container portion 33 has an outer peripheral surface (side surface), a terminal surface (end surface), and a surface (bevel surface) 33c which is formed between them. As shown in FIG. 5, the surface 33c curves inwardly, in the radial direction of the first container portion 33, from the outer peripheral surface to the terminal surface.

The second container portion 34 has a cylindrical shape having a bottom. The second container portion 34 may have a length A34 of, for example, 100 mm to 300 mm along an axis line L34. As shown in FIG. 5, the second container 34 has a second protruding ledge 39 on its inner peripheral surface. The second protruding ledge 39 inwardly protrudes in a radial direction of the second container 34, and spirally extends from a bottom portion 34a to an aperture end portion 34b. The bottom portion 34a is a first end portion of the second container portion 34 in the axis line L34, and the aperture end portion 34b is a second end portion of the second container portion 34 in the axis line L34. Specifically, when seen from the bottom portion 34a of the second container portion 34, the second protruding ledge 39 spirally extends from the bottom portion 34a to the aperture end portion 34b so that the second protruding ledge 39 rotates clockwise, along the inner peripheral surface of the second container portion 34, with respect to the axis line L34. Namely, the second protruding ledge 39 rotates inversely to the first protruding ledge 36. The first protruding ledge 36 of the first container portion 33 and the second protruding ledge 39 of the second container portion 34 may have a pitch A1 of, for example, 20 mm to 40 mm, respectively. Further, the first protruding ledge 36 and the second protruding ledge 39 may each have a protruding amount A2 of 3 mm to 10 mm from that portion of the inner peripheral surface which the first protruding ledge 36 or the second protruding ledge 39 is not formed.

The bottom portion 34a of the second container portion 34 has an outer peripheral surface (side surface), a terminal surface (end surface) 34c, and a surface (bevel surface) which is formed between them. The surface formed therebetween curves inwardly, in the radial direction of the second container portion 34, from the outer peripheral surface to the terminal surface 34c. Further, the terminal surface 34c of the bottom portion 34a has a partially globe shape whose central portion protrudes outwardly in a direction along the axis line L34. Further, a plurality of (two in the present embodiment) guiding protruding slips 40 are provided, and positioned with a certain space from a terminal surface of the aperture end portion 34b, on an outer peripheral surface of the aperture end portion 34b. Further, the guiding protruding slips 40 outwardly protrude in the radial direction of the second container portion 34, respectively. The guiding protruding slips 40 may have a length of, for example, 2 mm to 6 mm along the axis line L34, respectively.

The length A34 of the second container portion 34 is longer than the length A33 of the first container portion 33, and may be 30 mm or further longer than the length A33. For example, the length A33 of the first container portion 33 is 150 mm, and the length A34 of the second container portion is 215 mm. Further, the first container portion has a bore diameter D33 excluding the first protruding ledge 36, and the second container portion has a bore diameter D34 excluding the second protruding ledge 39. The bore diameters D33 and D34 may be in a range of 30 mm to 200 mm.

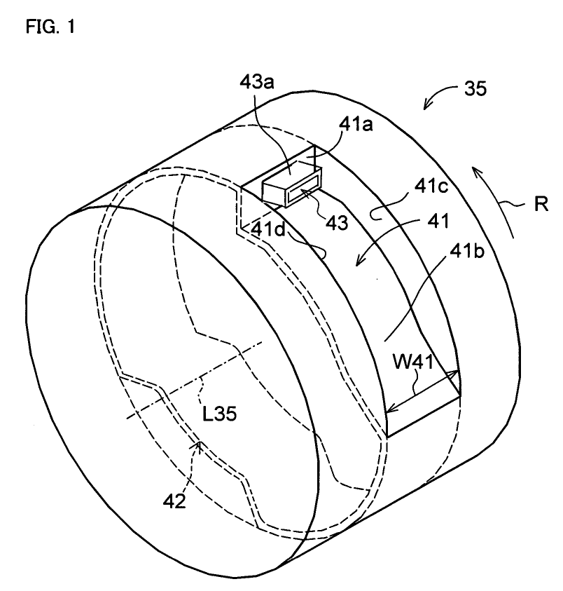

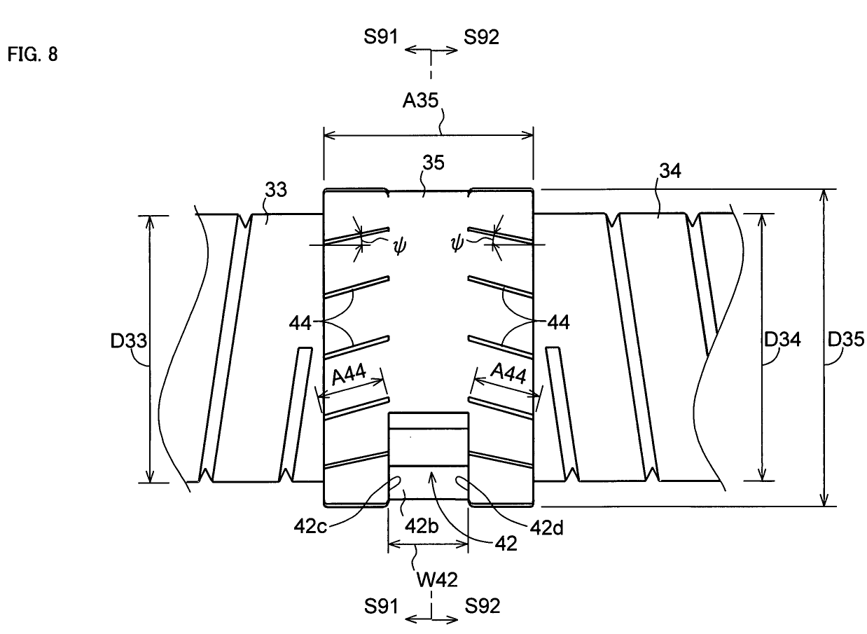

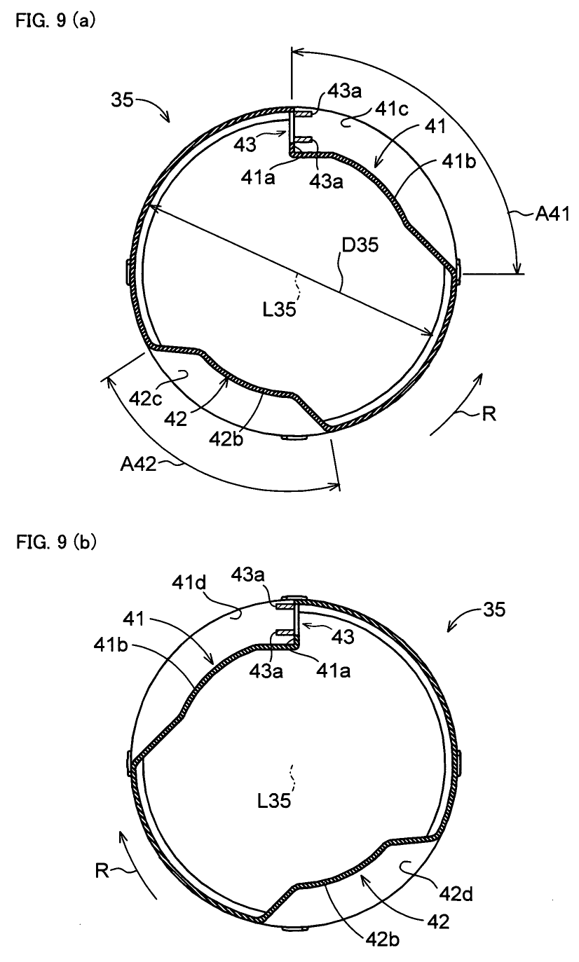

FIG. 1 is a perspective view illustrating the third container portion 35. FIG. 8 is an enlarged front view illustrating a vicinity of the third container portion 35. FIG. 9(a) is a cross sectional view taken along line S91-S91 of FIG. 8. FIG. 9(b) is a cross sectional view taken along line S92-S92 of FIG. 8.

As shown in FIG. 1, the third container portion 35 has substantially cylindrical shape. Specifically, the third container portion 35 includes a first recess portion (recess portion) 41 on its outer peripheral surface. Location of the first recess portion is a central portion of the outer peripheral surface of the third container portion 35 in an axis line L35. The first recess portion 41 depresses inwardly in a radial direction of the third container portion 35. The third container portion 35 further includes a second recess portion 42 on that location of its outer peripheral surface which is a certain distance away from the first recess portion 41. Further, in the first recess portion 41, a discharging opening 43 is provided to discharge the developer. Note that the third container portion 35 rotates with respect to the axis line L35. Note also that the discharging opening 43 is formed in a downstream of the rotation direction R of the third container portion 35. The third container portion 35 may have a length A35 of, for example, 50 mm to 150 mm along the axis line L35. The third container portion 35 has a bore diameter D35 larger than the respective bore diameters D33 and D34 of the first container portion 33 and the second container portion 34, the bore diameter D35 excluding the first recess portion 41 and the second recess portion 42. The bore diameter D35 may be in a range of, for example, 32 mm to 205 mm.

Here, detail description about shapes of the first recess portion 41 and the second recess portion 42 is made. The first recess portion 41 extends along the rotation direction R. The first recess portion 41 has a length A41 (shown in FIG. 9(a)) along the rotation direction R, and has a length W41 (shown in FIG. 1) along the axis line L35. The length A41 is longer than the length W41. Further, the first recess portion 41 includes a terminal wall (end wall) 41a formed on a downstream end, which is one end associated with downstream of the rotation direction R. The terminal wall 41a has a surface orthogonal to the rotation direction R. The discharging opening 43 is formed on a portion of the terminal wall 41a.

The second recess portion 42 extends along the rotation direction R. The second recess portion 42 has a length A42 along the rotation direction R, and has a length W42 along the axis line L35. The length A42 is longer than the length W42. The second recess portion 42 is formed, on the outer peripheral surface of the third container portion 35, with a certain distant away from the first recess portion 41. It is preferable that the second recess portion 42 be so formed that the second recess portion 42 faces the first recess portion 41 with respect to the axis line L35. The length A41 of the first recess portion 41 is preferably as large as ¼ or greater of the outer peripheral surface of the third container portion 35, and is preferably smaller than ½ thereof, the outer peripheral surface excluding the first recess portion 41 and the second recess portion 42. Specifically, the length A41 of the first recess portion 41 is preferably in a range of 20 mm to 150 mm, and the length W41 thereof is preferably in a range of 20 mm to 150 mm. Further, the length A42 of the second recess portion 42 is preferably 20 mm to 150 mm, and the length W42 thereof is preferably 20 mm to 80 mm.

Further, as shown in FIG. 1, the first recess portion 41 includes a bottom wall 41b, the first side wall 41c, and the second side wall 41d. The bottom wall 41b of the first recess portion 41 extends along the rotation direction R. Firstly, the bottom wall 41b has a downstream end, which is one end associated with downstream of the rotation direction R. The downstream end of the bottom wall 41b is connected to a radial inner end of the terminal wall 41a, the radial inner end being one end positioned inwardly in the radial direction of the third container portion 35. Further, the bottom wall 41b has an upstream end, which is one end associated with upstream of the rotation direction R. The upstream end of the bottom wall 41b is connected to that part of the outer peripheral surface of the third container portion 35 which is between the first recess portion 41 and the second recess portion 42. They are connected to each other in such a manner that the upstream end of the bottom wall 41b and the part of the outer peripheral surface form an obtuse angle. Between the downstream end of the bottom wall 41b and the upstream end thereof, the bottom wall 41b has a central portion. The central portion is depressed inwardly, in the radial direction of the third container portion 35, from that portion of the outer peripheral surface of the third container portion 35 which excludes the first recess portion 41 and the second recess portion 42. The central portion has a substantially partially cylindrical shape whose axis is the axis line L35 of the third container portion 35. The central portion of the bottom portion 41b of the first recess portion 41 has a surface preferably having a curvature radius of, for example, 10 mm to 90 mm.

Next, the first side wall 41c of the first recess portion 41 is a first end portion of the first recess portion 41, the first end portion being one end portion in a direction along the axis line L35. The first side wall 41c extends along the rotation direction R. The first side wall 41c has a downstream end, which is one end associated with the downstream of the rotation direction R. The downstream end of the first side wall 41c is connected to a first end of the terminal wall 41a, the first end being one end in a direction along the axis line L35. Further, the first side wall 41c has a radial inner end, which is one end positioned inwardly in the radial direction of the third container portion 35. The radial inner end of the first side wall 41c is connected to a first end of the bottom wall 41b, the first end being one end in a direction along the axis line L35. Furthermore, the first side wall 41c has a radial outer end, which is the other end positioned outwardly in the radial direction of the third container portion 35. The radial outer end of the first side wall 41c is connected to that outer peripheral surface of the third container portion 35 which excludes the first recess portion 41 and the second recess portion 42. Next, the second side wall 41d of the first recess portion 41 is a second end portion of the first recess portion 41, the second end being the other end portion in a direction along the axis line L35. The second side wall 41d extends along the rotation direction R. The second side wall 41d has a downstream end, which is an end associated with the downstream of the rotation direction R. The downstream end of the second side wall 41d is connected to a second end of the terminal wall 41a, the second end being the other end in a direction along the axis line L35. Further, the second side wall 41d has a radial inner end, which is one end positioned inwardly in the radial direction of the third container portion 35. The radial inner end of the second side wall 41d is connected to the second end of the bottom wall 41b. Furthermore, the second side wall 41d has a radial outer end, which is the other end positioned outwardly in the radial direction of the third container portion 35. The radial outer end of the second side-wall 41d is connected to that outer peripheral surface of the third container portion 35 which excludes the first recess portion 41 and the second recess portion 42. When seen from the bottom wall 41b, the first wall 41c and the second wall 41d extend outwardly, in the radial direction of the third container portion 35, from the bottom wall 41b. The bottom wall 41b is perpendicular to the first side wall 41c, and to the second side wall 41d.

The discharging opening 43 is provided on a central portion of the terminal wall 41a of the first recess portion 41, specifically, on that portion of the central portion of the terminal wall 41a which is located outwardly with respect to the center of the central portion in the radial direction. Further, the discharging opening 43 has a rectangular shape whose longitudinal sides are along the axis line L35. Specifically, the discharging opening 43 is located: outwardly, in the radial direction, with respect to the downstream end of the bottom wall 41b; and closer to the second end portion of the terminal wall 41a than the downstream end of the first side wall 41c; and closer to the first end portion of the terminal wall 41a than the downstream end of the second side wall 41d. More specifically, the discharging opening 43 has an outer radial side, which is one side disposed outwardly in the radial direction, and the outer radial side of the discharging opening 43 is connected to that inner peripheral surface of the third container portion 35 which excludes the first and the second recess portions 41 and 42.

Further, as shown in FIG. 1, a regulating member 43a having a tube-like shape (more specifically, square tube-like shape) is perpendicularly provided on the terminal wall 41a so that the regulating member 43 surrounds the discharging opening 43 of the first recess portion 41. The regulating member 43a is provided so as to regulate a discharging amount of the developer. Note that, in the present embodiment, the regulating member 43a is perpendicular to the terminal wall 41a, however, the present invention is not limited to this. The regulating member 43a may be formed substantially along the rotation direction of the third container portion 35 (the container main body 31) so that the regulating member 43a surrounds the discharging opening 43.

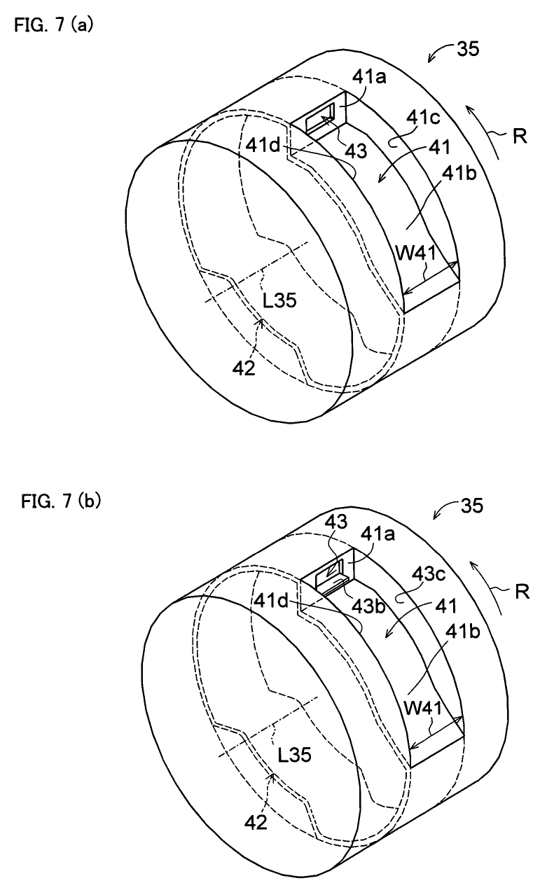

A height of the regulating member 43a is not particularly limited, however, the regulating member 43a preferably has a height of, for example, 2 mm to 10 mm from the terminal wall 41a. This arrangement ensures that the amount of the developer to be discharged can be more securely regulated. Further, a method for forming the regulating member 43a in the third container portion 35 is not particularly limited, and the regulating member 43a may be formed in accordance with various well-known conventional methods. For example, the third container portion 35 having no regulating member (shown in FIG. 7(a)) and the regulating member 43a having a tube-like shape are separately manufactured, and then the regulating member 43a is attached to the discharging opening 43 of the third container portion 35.

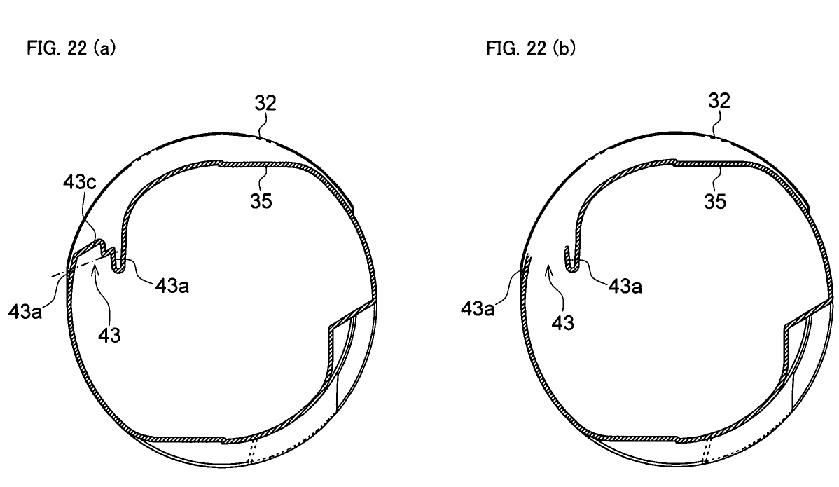

Alternatively, the third container portion 35 and the regulating member 43a may be fabricated in one piece by carrying out a blow forming. FIG. 22(a) and FIG. 22(b) shows how the third container portion 35 is formed in accordance with the blow forming. In this case, the third container portion 35 having a cylindrical shape is firstly formed so that a rise portion 43c is formed in its cross sectional surface as shown in FIG. 22(a). Then, a portion (shown in FIG. 22(a)) indicated by a chain line is cut off, thereby obtaining the third container portion 35 including the discharging opening 43 and the regulating member 43a as shown in FIG. 22(b).

Because the regulating member 43a is provided in the developer container 30 of the present embodiment, the regulating member 43a prevents a self weight-induced flow-in of the developer into the first recess portion 41 when the developer is discharged, via the discharging opening 43, to the first recess portion 41. A detailed description about how the regulating member 43a prevents the self weight-induced flow-in of the developer into the first recess portion 41 is made later.

It should be noted that the regulating member 43a of the present embodiment has such a shape that the developer is prevented from flowing too much, due to its gravity (weight), into the first recess portion 41, and the shape is not limited to the tube-like shape (shown in FIG. 1). The regulating member may have, for example, a plate shape such as a regulating member 43b (shown in FIG. 7(b)). The regulating member 43b is perpendicular to that end portion of the discharging opening 43 which is near the bottom wall 41b of the first recess portion 41, thereby preventing the self weight-induced flow-in of the developer into the first recess portion 41.

Specifically, the second recess portion 42 includes a bottom wall 42b, a first side wall 42c, and a second side wall 42d. The bottom wall 42b of the second recess portion 42 extends along the rotation direction R. The bottom wall 42b has a downstream end, which is one end associated with downstream of the rotation direction R, and has an upstream end portion, which is another end associated with upstream of the rotation direction R. The downstream end of the second recess portion 42 and the upstream end portion thereof are connected to that parts of the outer peripheral surface of the third container portion 35 which are between the first recess portion 41 and the second recess portion 42 (i.e., which excludes the first recess portion 41 and the second recess portion 42), respectively. Between the downstream end of the bottom wall 42b and the upstream end portion thereof, the bottom wall 42b has a central portion, which is along the rotation direction R. The central portion is disposed inwardly, in the radial direction of the third container portion 35, from that part of the outer peripheral surface of the third container portion 35 which excludes the first recess portion 41 and the second recess portion 42. Substantially, the central portion has a shape which is partially cylindrical with respect to the axis line L35 of the third container portion 35. The central portion of the bottom portion 42b of the second recess portion 42 has an outer peripheral surface preferably having a curvature radius of, for example, 10 mm to 90 mm.

The first side wall 42c of the second recess portion 42 is located in association with a first end portion of the second recess portion 42, the first end being one end in the direction along the axis line L35. The first side wall 42c extends along the rotation direction R. The first side wall 42c has a radial inner end, which is one end positioned inwardly in the radial direction of the third container portion 35. The radial inner end of the first side wall 42c is connected to a first end of the bottom wall 42b, the first end being one end in the direction along the axis line L35. Further, the first side wall 42c has a radial outer end, which is one end positioned outwardly in the radial direction. The radial outer end of the first side wall 42c is connected to the outer peripheral surface of the third container portion 35, the outer peripheral surface excluding the first recess portion 41 and the second recess portion 42. Next, the second side wall 42d of the second recess portion 42 is formed toward a second end portion of the second recess portion 42, the second end being the other end in the direction along the axis line L35. The second side wall 42d has a radial inner end, which is one end positioned inwardly in the radial direction of the third container portion 35. The radial inner end of the second side wall 42d is connected to a second end of the bottom wall 42b, the second end being the other end in the direction along the axis line L35. Further, the second side wall 42d has a radial outer end, which is one end positioned outwardly in the radial direction. The radial outer end of the second side wall 42d is connected to the outer peripheral surface of the third container portion 35, the outer peripheral surface excluding the first recess portion 41 and the second recess portion 42. The first wall 42c and the second wall 42d outwardly extend, in the radial direction of the third container portion 35, from the bottom wall 42b. The bottom wall 42b is perpendicular to the first side wall 42c, and to the second side wall 42d.

See FIG. 8. On that outer peripheral surfaces of the first end portion and the second end portion of the third container portion 35 which exclude the first recess portion 41 and the second recess portion 42, a plurality of discharging guides 44 are provided with intervals along the circumferential direction. Each of the discharging guides 44 provided on the first end portion of the third container 35 declines, toward the first end portion, with respect to the rotation direction R. Also, each of the discharging guides 44 provided on the second end portion of the third container portion 35 declines, toward the second end portion, with respect to the rotation direction R. The discharging guide 44 outwardly protrudes, in the radial direction of the third container portion 35, from that outer peripheral surface of the third container portion 35 which excludes the first recess portion 41 and the second recess portion 42. The discharging guide 44 may have a protruding amount of, for example, 1 mm. The discharging guide 44 has a longitudinal side whose length may be 24 mm. The discharging guide 44 and a width of the third container portion 33 may form an angle ψ of, for example, 30°.

The container main body 31 is so formed in one piece that the first end potion of the third container portion 35 and the aperture end portion 33b are connected to each other, and that the second end portion of the third container portion 35 and the aperture end portion 34b of the second container portion 34 are connected to each other. The container main body 31 may be manufactured by, for example, blow forming a synthetic resin such as polyethylene. This makes it possible to manufacture the container main body 31 with ease, and to reduce components of the developer container 30.

Therefore, the bottom portion 33a of the first container 33 is the first end portion 33a of the container main body 31, and the bottom portion 34a of the second container portion 34 is the second end portion 34a of the container main body 31. As such, the container main body 31 is so formed that the respective axis lines L33, L34, and L35 of the first container portion 33, the second container portion 34, and the third container portion 35 are coincident with one another. Further, in this state, the third container portion 35 is a central portion of the container main body 31 along the axis line L31, i.e., is disposed between the first and the second ends portion 33a and 34a of the container main body 31. Therefore, the first recess portion 41, the second recess portion 42, and the discharging opening 43 of the third container portion 35 are disposed in the central portion of the container main body 31, i.e., are disposed between the first and the second ends portion 33a and 34a of the container main body 31. Further, the axis line L31 of the container main body 31 is constituted of the respective axis lines L33, L34, and L35 of the first container portion 33, the second container portion 34, and the third container portion 35.

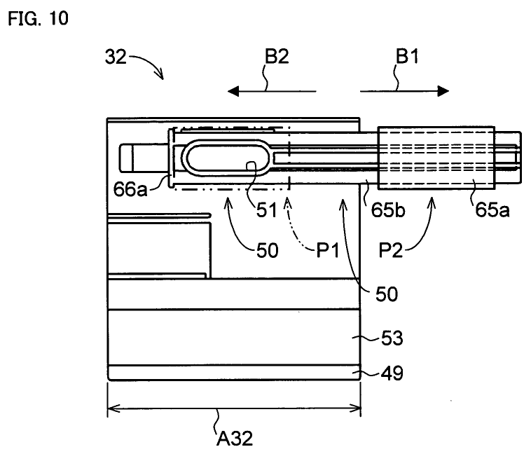

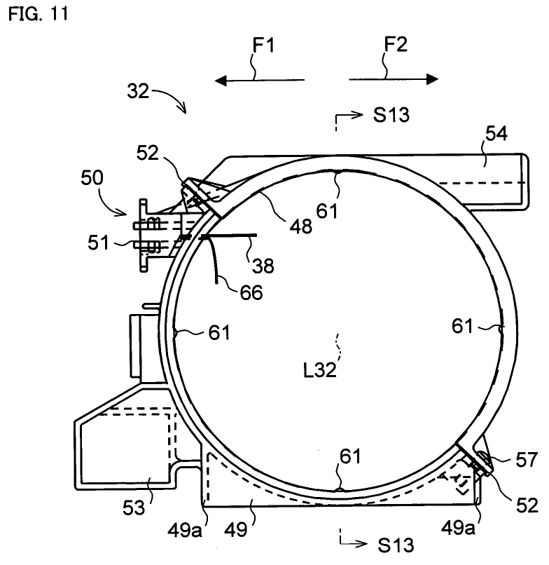

FIG. 10 is a front view illustrating the supporting member 32. FIG. 11 is a right side view illustrating the supporting member 32. The supporting member 32 has a substantially cylindrical shape, and includes an inner peripheral surface 48 for supporting, by wholly covering the outer peripheral surface of the third container portion 35, at least the third container portion 35 of the container main body 31 having the aforementioned structure. The inner peripheral surface 48 is a cylindrical inner peripheral surface whose center is an axis line L32. The supporting member 32 further includes a supporting board 49 having abutment portions 49a. The abutment portions 49a of the supporting board 49 may be provided, for example, on two flat surfaces of the supporting board 49, the two flat surfaces having a rectangular shape whose longitudinal sides are parallel to the axis line L32. By abutting the abutment portions 49a of the supporting board 49 to a horizontal flat plane, an axis line L48 of the inner peripheral surface 48 of the supporting member 32 is disposed parallelly to the horizontal flat plane. The supporting member 32 has a length A32 along the axis line L32, and the length A32 is longer than the length A35 of the third container portion 35. The length A32 of the supporting member 32 may be in a range of, for example, 60 mm to 170 mm.

When the supporting board 49 is thus placed on the horizontal flat surface, a discharging portion 50 is disposed on an upper portion of the supporting member 32. The discharging portion 50 protrudes in a direction F1, which is one direction of first horizontal directions. In a central portion of the discharging portion 50, a through opening (conducting opening) 51 having an oval shape is provided, the central portion being in the axis line L32. The through opening 51 penetrates the discharging portion 50 along the direction F1, and extends parallel to the axis line L32 of the supporting member 32. Further, the through opening 51 has a bore diameter in its longitudinal direction, and the bore diameter has a size which is similar to or larger than the length W41 of the first recess portion 41, and the length W42 of the second recess portion 42.

The discharging portion 50 of the supporting member 32 is provided with a shutter section 65. The shutter section 65 opens and closes that mouth of downstream end of the through opening 51 which is formed in downstream of the direction F1. The shutter section 65 includes a shutter 65a and a shutter guide 65b. The shutter guide 65b extends in directions B1 and B2, which are second horizontal directions perpendicular to the directions F1 and F2, respectively. The shutter guide 65b has an upstream end portion, which is one end portion associated with upstream of the direction B1. In the upstream end portion of the shutter guide 65b, the through opening 51 is disposed. The shutter 65a is supported by the shutter guide 65 so that the shutter 65a can freely slide to move in the direction B1 and the direction B2, which is inverse to the direction B1.

The shutter 65a can slide, along the shutter guide portion 65b, to a closing position P1 (indicated by a chain double dashed line in FIG. 10), and to an opening position P2. When the shutter 65a is in the closing position P1, the through opening 51, which is formed in the downstream of the direction F1, is closed. When in the opening position P2, the through opening 51 is opened. The shutter 65a is prevented from sliding further, in the direction B2, from the closing position P1. Also, the shutter 65a is prevented from sliding further, in the direction B2, from a downstream end portion of the shutter guide 65b, the downstream end portion being an end associated with downstream of the direction B2. Namely, the opening position P2 is located between the closing position P1 and a downstream end portion of the shutter guide 65b, the downstream end portion being associated with a downstream of the direction B1. Thus, the shutter 65a can be located in the opening position P2 by sliding the shutter 65a, in the direction B1, from the closing position P1. Similarly, the shutter 65a can be located in the closing position P1 by sliding the shutter 65a, in the direction B2, from the opening position P2.

The supporting member 32 further includes a leading member 38 serving as leading means, and a sealing sheet 66 serving as sealing means. The leading member 38 is made of a polymer resin such as polyethylene terephthalate (PET), and is in the form of sheet having flexibility and elasticity. The leading member 38 has an anchorage end portion within the through opening 51, and the anchorage end portion extends, in a direction F2 (shown in FIG. 11), to that aperture end of through opening 51 which faces the inner peripheral surface 48 of the supporting member 32. The sealing sheet 66 is made of, for example, polyethylene, and is in the form of sheet having flexibility. The sealing sheet 66 has an anchorage end portion within the through opening 51, and extends, in the direction F2, to the aperture end of through opening 51. The anchorage end portion of the leading member 38 is placed on an upper surface of the anchorage end portion of the sealing sheet 66. A detailed description of the leading member 38 and the sealing sheet 66 is made later.

Further, the supporting member 32 includes two connecting protruding sections 52, which outwardly protrudes in a radial direction of the supporting member 32. One of the connecting protruding sections 52 is provided in a portion higher than the discharging portion 50 when the supporting board 49 is placed on the horizontal flat plane. The other connecting protruding section 52 is provided symmetrically to the foregoing connecting protruding section 52 with respect to the axis line L32. The supporting member 32 further includes a first guide 53. The first guide 53 is disposed below the discharging portion 50, and protrudes in the direction F1, and extends parallel to the axis line L32 when the supporting board 49 is placed on the horizontal flat plane. The supporting member 32 further includes a second guide 54. The second guide 54 is provided above the discharging portion 50, and protrudes in the direction F2, which is inverse to the direction F1, and extends parallel to the axis line L32 when the supporting board 49 is placed on the horizontal flat plane.

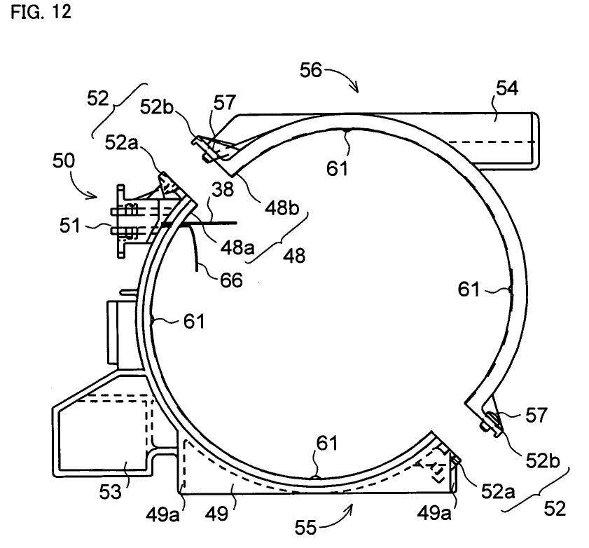

FIG. 12 is a right side exploded diagram illustrating the supporting member 32. When the supporting member 32 is placed on the horizontal flat plane, the supporting member 32 can be divided in two with respect to an imaginary flat surface, which the axis line L32 passes and inclines in the direction F1. Specifically, the supporting member 32 can be divided into a first supporting section 55 disposed below the imaginary flat surface, and a second supporting section 56 disposed above the imaginary flat surface. Of the members included by the supporting member 32, the first supporting section 55 includes: the first guide 53, the discharging portion 50, respective halved sections 52a of the connecting protruding sections 52, the supporting board 49, and that section 48a of the inner peripheral surface 48 which is associated with the first guide 53. Of the members included by the supporting member 32, the second supporting section 56 includes: the second guide 54, respective other halved sections 52b of the connecting protruding sections 52, and that section 48b of the inner peripheral surface 48 which is associated with the second guide 54.

The first supporting section 55 and the second supporting section 56 are detachably coupled with each other by screw members 57. Specifically, the respective halved sections 52a of the connecting protruding portions 52 are coupled, by the screw members 57, with the respective other halved sections 52b thereof. Before the supporting member 32 is assembled with the container main body 31, the supporting member 32 is disassembled in advance. The supporting member 32 thus taken apart covers that portion of the container main body 31 which includes the first recess portion 41, the second recess portion 42, and the discharging opening 43. This allows the container main body 31 to be wholly supported. As such, the assembly can be carried out with ease.

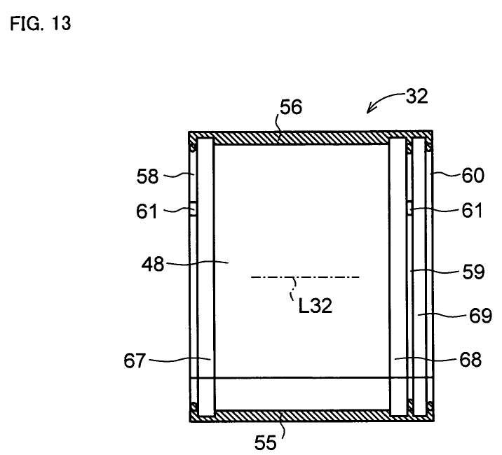

FIG. 13 is a cross sectional view taken along a line S13-S13 (shown in FIG. 11). Hereinafter, FIG. 11 is also referred. The inner peripheral surface 48 of the supporting member 32 includes a first supporting rise portion 58 in its first end portion, which is one end portion in the axis line L32. The first supporting rise portion 58 inwardly protrudes in the radial direction of the supporting member 32, and extends entirely along the first end portion of the supporting member 32. The inner peripheral surface 48 of the supporting member 32 further includes a second supporting rise portion 59 in its second end portion, which is the other end portion in the axis line L32. The second supporting rise portion 59 inwardly protrudes in the radial direction of the supporting member 32, and extends entirely along the second end portion of the supporting member 32. Further, the inner peripheral surface 48 of the supporting member 32 further includes a third supporting rise portion 60 on the second end portion of the supporting member 32. The third supporting rise portion 60 is so located that the second end portion is closer to the third supporting rise portion 60 than the second supporting rise portion 59 is, and there is a certain space between the second and the third supporting rise portion 59 and 60. The third supporting rise portion 60 inwardly protrudes in the radial direction of the supporting member 32, and extends entirely along the second end portion. The space between the second and the third supporting rise portion 59 and 60 is a little larger than the length of the guiding protruding slip 40 of the second container portion 34 of the container main body 31, the length being along the axis line L34.

On each of the first supporting rise portions 58 and the second supporting rise portions 59, a plurality of (four, in the present embodiment) protruding supporters 61 are provided with intervals along the circumferential direction. Each of the protruding supporters 61 inwardly protrudes in the radial direction of the supporting member 32. The protruding supporter 61 has a top end portion, which is one end positioned inwardly in the radial direction. The top end portion has a supporting surface that has a curved shape that corresponds to an outer peripheral surface of semi-cylinder. Further, an imaginary circle, which passes along the top end portions of the protruding supporters 61 provided on the first and the second supporting rise portion 58 and 59, has a diameter slightly larger than an external diameter of the outer peripheral surface of the first container 33, and that external diameter of the outer peripheral surface of the second container portion 34 which excludes the guiding protruding slip 40. Further, the third supporting rise portion 60 has a bore diameter slightly larger than that external diameter of the outer peripheral surface of the second container portion 34 which excludes the guiding protruding slip 40.

Further, in the first end portion of the inner peripheral surface 48 of the supporting member 32, a first supporting recess portion 67 is provided. The first supporting recess portion 67 is adjacent to the first supporting rise portion 58, and the second end portion is closer to the first supporting recess portion 67 than the first supporting rise portion 58. The first supporting recess portion 67 depressed outwardly in the radial direction of the supporting member 32, and extends entirely along the first end portion of the inner peripheral surface 48. Further, in the second end portion of the inner peripheral surface 48 of the supporting member 32, a second supporting recess portion 68 is provided. The second supporting recess portion 68 is adjacent to the second supporting rise portion 59, and is more associated with the first end portion than the second supporting rise portion 59 is. The second supporting recess portion 68 depressed outwardly in the radial direction of the supporting member 32, and extends entirely along the second end portion of the inner peripheral surface 48. Further, in the second end portion, a third supporting recess portion 69 is provided between the second supporting rise portion 59 and the third supporting rise portion 60. The third supporting recess portion 69 depressed outwardly in the radial direction of the supporting member 32, and extends entirely along the second end portion of the inner peripheral surface 48. The third supporting recess portion 69 has a length slightly longer than the guiding protruding slip 40 of the second container portion 34 of the container main body 31, the length being along the axis line L32.

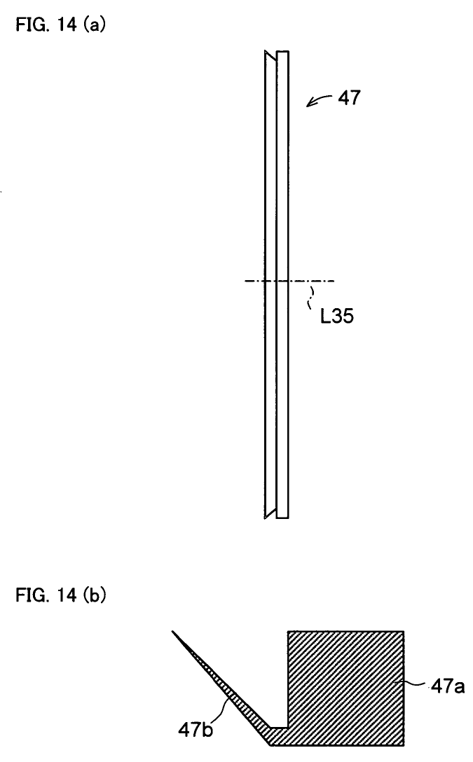

FIG. 14(a) is a front view illustrating a sealing material 47. FIG. 14(b) is a cross sectional view illustrating the sealing material 47 taken perpendicularly to its outer peripheral surface. The sealing material 47 serves as sealing means, and is made of a synthetic resin having flexibility and elasticity, such as silicone rubber. The sealing material 47 (shown in FIG. 14(a)) has a substantially circular ring shape. The sealing material 47 includes a base portion 47a and a contact portion 47b as shown in FIG. 14(b). The base portion 47a of the sealing material 47 has a cross section having a rectangular shape perpendicular to the outer peripheral surface of the sealing material 47, whose center is the axis line L35. The contact portion 47b is formed on a first end portion of the base portion 47a, the first end portion being one end portion in a direction along the axis line L35. The contact portion 47b inclines, outwardly in a radial direction of the sealing material 47, from its end portion to its other end portion.

The base portion 47a of the sealing material 47 has an inner peripheral surface whose diameter is smaller than the outer peripheral surface of the first container portion 33 of the container main body 31, and than that outer peripheral surface of the second container portion 34 of the container main body 31 which excludes the guiding protruding slip 40. Further, the base portion 47a and the contact portion 47b of the sealing member 47 respectively have outer peripheral surfaces whose diameters are coincident with or larger than an imaginary circle centered at the axis line L31, which passes the outer peripheral surfaces of the discharging guides 44. The sealing material 47 has a length, which is coincident with or smaller than the respective lengths of the first supporting recess portion 67 and the second supporting recess portion 68 of the supporting member 32, all the lengths here being along their respective axis lines.

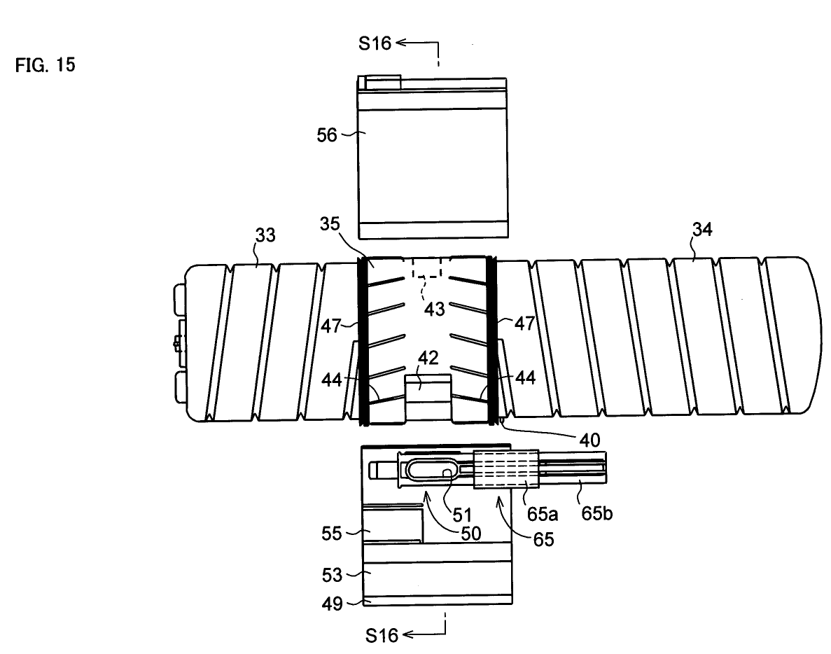

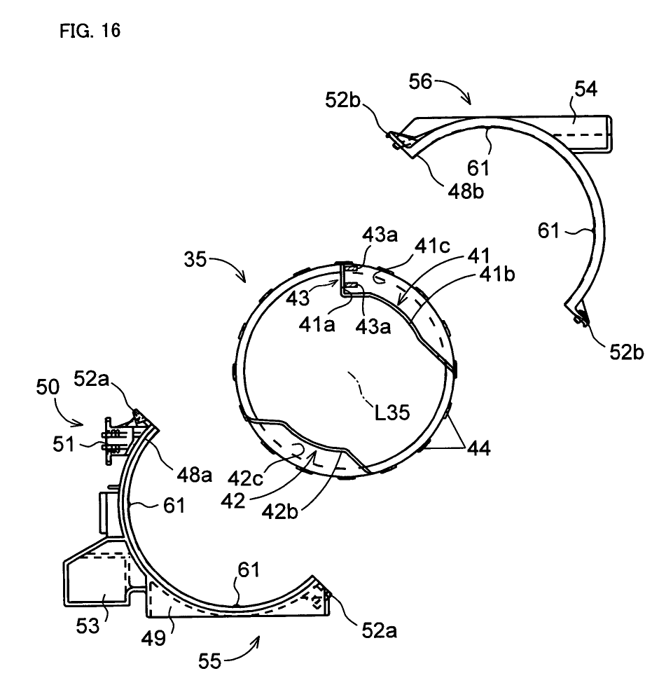

FIG. 15 is a front view illustrating an assembly of the developer container 30. FIG. 16 is a cross sectional view taken along a line S16-S16 of FIG. 15. Before the assembly, the supporting member 32 is disassembled into the first supporting section 55 and the second supporting section 56. Further, here, one of two sealing materials 47 is provided around the aperture end portion 33b of the first container portion 33 with a gap therebetween. Besides, the base portion 47a of the sealing material 47 makes close contact with the terminal surface of a first end portion of the third container portion 35, the first end portion being one end portion in the axis L35. In this way, the sealing material 47 is fixed to the first container portion 33 of the container main body 31. The other sealing material 47 is provided around the aperture end portion 34b of the second container portion 34. The other sealing material 47 is positioned closer to the first end portion of the second container portion 34 than the guiding protruding slip 40. Besides, the base portion 47a of the other sealing material 47 makes close contact with a second end portion of the third container portion 35, the second end portion being the other end portion in the axis L35. On this account, the other sealing material 47a is fixed to the second container portion 34 of the container main body 31.

Then, the first supporting section 55 and the second supporting section 56 is assembled so that, by being applied inwardly in the radial direction, they sandwich that portion of the container main body 31 which includes the third container portion 35. The first supporting section 55 and the second supporting section 56 thus arranged are coupled with the screw member 57.

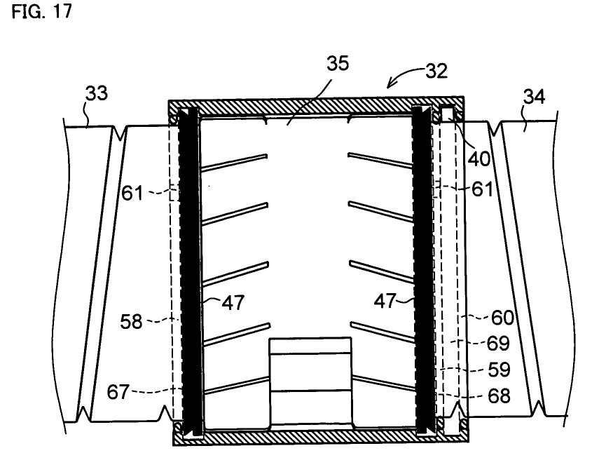

FIG. 17 is a cross sectional view illustrating the developer container 30 taken along a line S17-S17 of FIG. 4. When the container main body 31 is supported by the supporting member 32, the axis line L31 of the container main body 31 is absolutely or substantially coincident with the axis line L32 of the inner peripheral surface 48 of the supporting member 32. Therefore, the container main body 31 can be freely rotated the axis line L31 with respect to the supporting member 32. When the supporting board 49 of the supporting member 32 is placed on a horizontal flat plane, the first container portion 33 and the second container portion 34 have a certain space from the horizontal flat plane, respectively, and the horizontal flat plane and the rotation axis line L31 are parallel to each other.

Specifically, the supporting member 32 is assembled with the container main body 31 so that the protruding supporters 61 of the first supporting rise portion 58 make contact with the outer peripheral surface of the first container portion 33, and so that the protruding supporters 61 of the second supporting rise portion 59 make contact with that outer peripheral surface of the second container portion 34 which excludes the guiding protruding slip 40. Namely, the outer peripheral surface of the first container portion 33 is supported, in four locations, by the protruding supporters 61 of the first supporting rise portion 58. The protruding supporters 61 are provided with intervals along the circumferential direction. Further, that outer peripheral surface of the second container portion 34 which excludes the guiding protruding slip 40 is supported, at four points, by the protruding supporters 61 of the second supporting rise 59. The protruding supporters 61 are provided with intervals along the circumferential direction. On this account, a frictional force against the rotation of the container main body 31 can be dramatically reduced, the frictional force occurring (i) between the outer peripheral surface of the first container portion 33 and the first supporting rise portion 58, and (ii) between the outer peripheral surface of the second container portion 34 and the second supporting rise portion 59.

The sealing material 47 of the first container portion 33 is fitted into the first supporting recess portion 67 of the supporting member 32, and elastically abuts against a surface of a whole surface of the first supporting rise portion 58, the surface being associated with the second end of the inner peripheral surface 48. The other sealing material 47 of the second container portion 34 is fitted into the second supporting recess portion 68 of the supporting member 32, and entirely makes elastic contact with a surface of the first supporting rise portion 58, the surface being associated with the first end of the inner peripheral surface 48. With the two sealing materials 47, sealed is between the supporting member 32 and the container main body 31, the first and the second recess portion of the container main body 31, and the discharging opening 43 being positioned therebetween.

The guiding protruding slips 40 of the container main body 31 are fitted into the third supporting recess portion 69 of the supporting member 32. On this account, the container main body 31 is prevented from sliding, along the axis line L31, within the supporting member 32. The outer peripheral surfaces of the discharging guides 44 each make contact with the inner peripheral surface 48 of the supporting member 32. Thus, the supporting member 32 covers and supports at least that portion of the container main body 31 which includes the first recess portion 41 in such a manner that the container main body 31 can freely rotate with respect to the rotation axis line L31.

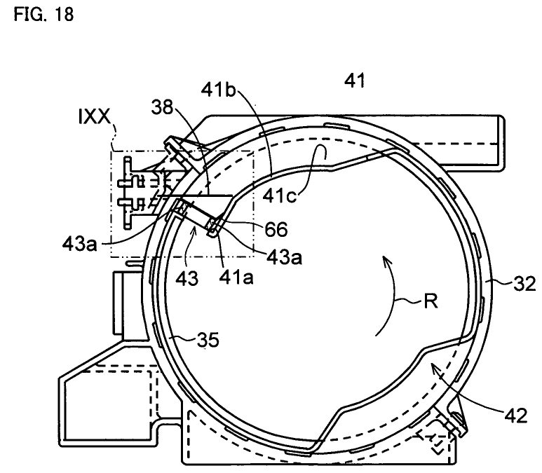

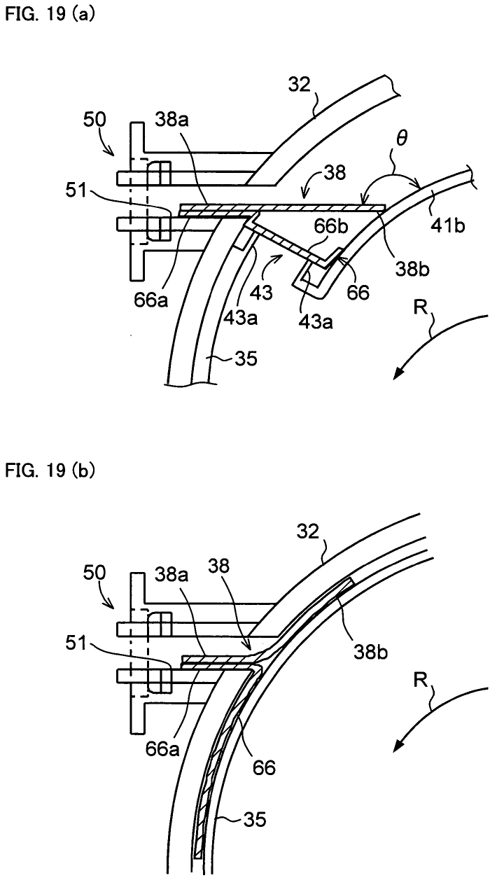

FIG. 18 is a cross sectional view illustrating the developer container 30 taken along a line S18-S18 of FIG. 3. FIG. 19(a) and FIG. 19(b) are enlarged view of IXX section indicated by a chain double-dashed line in FIG. 18. Further, FIG. 18 and FIG. 19(a) illustrates that the container main body 31 is in an initial state (i.e., state before carrying out the operation of discharging the developer) within the supporting member 32. In the inner peripheral surface of the supporting member 32, the leading member (leading means) 38 is provided. The leading member 38 leads the developer, discharged from the discharging opening 43 to the first recess portion 41, into the through opening 51.

The leading member 38 has the anchorage end portion 38a within the through opening 51, and the anchorage end portion extends, in the direction F1 (shown in FIG. 11), to that aperture end of through opening 51 which faces the inner peripheral surface 48 of the supporting member 32. Further, the leading member 38 has an unfixed portion 38b that can elastically abut, at an angle θ of 90°, at least against the outer peripheral surfaces of the respective bottom walls 41b and 42b of the first and the second recess portions 41 and 42 of the third container portion 35 of the container main body 31. Specifically, the angle θ is formed (i) by an upper surface of the unfixed portion 38b and the outer peripheral surface of the bottom wall 41b of the first recess portion 41, and (ii) by the upper surface of the unfixed portion 38b and the outer peripheral surface of the bottom wall 42b of the second recess portion 42.

The sealing sheet 66 has an anchorage end portion 66a within the through opening 51, and extends, in the direction F1, to that aperture end of through opening 51 which faces the inner peripheral surface 48. The sealing sheet 66 has a portion 66b, which is a portion excluding the anchorage end portion 66a. When the container main body 31 is in the initial state with respect to the supporting member 32, the portion 66b detachably makes contact with the bottom walls 41b, by using thermal adhesion or the like, so as to cover at least the discharging opening 43 (i.e., an aperture of the regulating member 43a) of the terminal wall 41a of the first recess portion 41. Thus, in the initial state, the discharging opening 43 is covered with the portion 66b of the sealing sheet 66. On this account, in the initial state, even if a user accidentally locates the shutter 65 of the shutter section 65 in the opening position P2, the developer contained in the container main body 31 can be prevented from leaking out from the through opening 51.

From the initial state, the container main body 31 is rotated, in the rotation direction R, around the rotation axis line L31. The rotation causes the portion 66b of the sealing sheet 66 to be apart from the terminal wall 41a of the first recess portion 41, thereby opening the discharging opening 43. Thereafter, the portion 66b thus detached from the terminal wall 41a bends in the rotation direction R, and is disposed between the third container portion 35 of the container main body 31 and the inner peripheral surface 48 of the supporting member 32, as shown in FIG. 19(b). On this account, the discharging opening 43 can be open with ease, by only rotating the container main body 31, without manually removing the sealing sheet 66.

When the supporting board 49 of the supporting member 32 is placed on a flat surface, and if the developer is contained in the container main body 31, there are two layers inside the container main body 31; a developer layer 63 and an air layer formed above the developer layer 63. When the container main body 31 rotates clockwise with respect to the rotation axis line L31 (when viewed from the first container portion 33), the developer of the developer layer 63 in the first container portion 33 is led by the first protruding ledge 36, and is supplied, along the rotation axis line L31, in a first supplying direction C1 (shown in FIG. 3), to the third container portion 35. Meanwhile, the developer contained in the second container portion 34 is led by the second protruding ledge 39, and is supplied, along the rotation axis line L31, in a second supplying direction C2 (shown in FIG. 3), to the third container portion 35. By thus rotating the container main body 31 with respect to the rotation axis line L31, the developer contained in the container main body 31 can be supplied to the discharging opening 43. Further, the developer sent in the first supplying direction C1, and the developer sent in the second supplying direction C2 collide each other in the third container portion 35. This stirs the developer.

When the developer is supplied, a force toward the third container 35 from the inner peripheral surfaces of the first container portion 33 and the second container portion 34 is exerted onto the developer. When the container main body 31 contains a large amount of developer, the developer positioned within a range of the protruding amount A2 of the first and the second protruding ledges 36 and 39 is mostly stirred by the rotation of the container main body 31. On this account, the developer is kept evenly in the container main body 31.

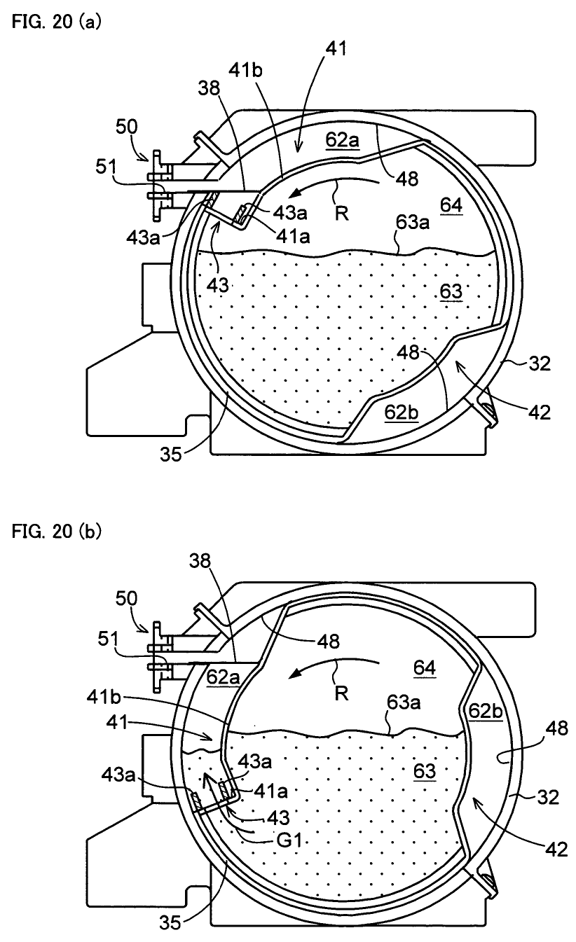

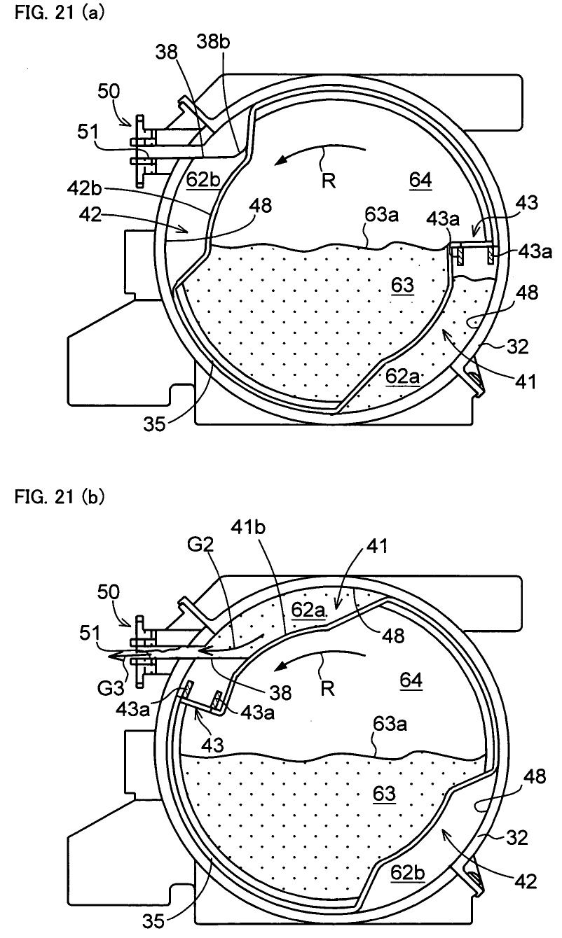

Here, the following description deals with how the developer in the third container portion 35 is led to the through opening 51 when the container main body 31 rotates, in the rotation direction R, around the rotation axis line L31, with reference to FIG. 20(a), FIG. 20(b), FIG. 21(a), and FIG. 21(b). Note that FIG. 1, FIG. 9(a), FIG. 9(b), and FIG. 17 are also referred.

When the container main body 31 is so supported by the supporting member 32 that the container main body 31 can freely rotate with respect to the rotation axis line L31, a first retention space 62a is formed between the first recess portion 41 of the third container portion 31 and the inner peripheral surface 48 of the supporting member 32. The first retention space 62a is a substantially closed space except that it is opened via the discharging opening 43, and extends from the discharging opening 43 toward the upstream of the rotation direction R. The first retention space 62 is connected, via the discharging opening 43, to the inside of the container main body 31. Further, a second retention space 62b is formed between the second recess portion 41 of the third container portion 31 and the inner peripheral surface 48 of the supporting member 32. The second retention space 62b is a substantially closed space.

Firstly, the container main body 31 rotates, in the rotation direction R, from such a state (i.e., the initial state) that the discharging opening 43 and the first retention space 62a are disposed above an upper level 63a of the developer layer 63 of the container main body 31 as shown in FIG. 20(a). Then, as shown in FIG. 20(b), the discharging opening 43 and a part of the first retention space 62a are disposed below the upper level 63a. On this occasion, the developer of the developer layer 63 is discharged into the first retention space 62a via the discharging opening 43 and the regulating member 43a as shown in an arrow G1 of FIG. 20(b).

The discharging opening 43 is provided on a central portion of the terminal wall 41a of the first recess portion 41, specifically, on that portion of the central portion of the terminal wall 41a which is located outwardly with respect to the center of the central portion in the radial direction. Further, the discharging opening 43 has a rectangular shape whose longitudinal sides are along the axis line L35. Specifically, the discharging opening 43 is located: outwardly, in the radial direction, with respect to the downstream end of the bottom wall 41b; and closer to the second end portion of the terminal wall 41a than the downstream end of the first side wall 41c; and closer to the first end portion of the terminal wall 41a than the downstream end of the second side wall 41d. Further, the regulating member 43a having tube-like shape is provided perpendicular to the terminal wall 41a so that the regulating member 43a surrounds the discharging opening 43.

If the discharging opening 43 occupies the whole terminal wall 41a, the rotation of the container main body 31 causes the developer to be densed, and the developer thus densed enters, the first retention space 62a, via the discharging opening 43, along the first recess portion 41 of the container main body 31 and the inner peripheral surface 48 of the supporting member 32. Thereafter, the container main body 31 further rotates in the rotation direction R. This possibly causes the first recess portion 41 and the inner peripheral surface 48 to put pressure on the developer that is kept in the first retention portion 41, thereby agglomerating the developer. On the contrary, in the present embodiment, the discharging opening 43 occupies a part of the terminal wall 41a of the first recess portion 41 as described above. That is, the discharging opening 43 has an aperture area that is smaller than an area of the terminal wall 41a. On this account, the discharging opening of the first retention space 62a spreads the developer over the first retention space 62a. This allows the developer discharged into the first retention space 62a to be fine particles. This can prevent the developer from the agglomeration caused by the rotation of the container main body 31.

Further, if the regulating member 43a is not provided, it is impossible to prevent the self weight-induced flow-in of the developer when the developer is discharged into the first recess portion 41. In this case, the amount of the developer supplied to the developing section of the image forming apparatus depends on how much the developer left in the container main body 31, and the developer therefore cannot be evenly supplied. Accordingly, images cannot always be evenly formed, thereby deteriorating qualities of images. Therefore, the regulating member 43a is provided in the developer container 30 of the present invention so as to prevent the self weight-induced flow-in of the developer.

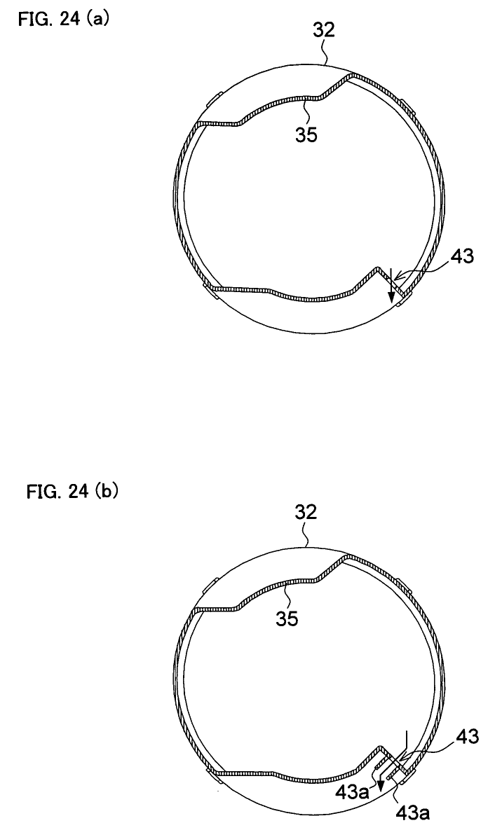

Here, the following description deals with how the regulating member 43a prevents the developer from being too much supplied due to the gravitational force imposed on the developer with reference to FIG. 24(a), and FIG. 24(b). FIG. 24(a) and FIG. 24(b) illustrate when the first recess portion 41 of the third container portion 35 is in the vicinity of a bottom dead center. The bottom dead center is a location in which the first recess portion 41 is positioned at a bottom of the rotation, and in which the maximum loads of the gravity is imposed on the developer. Note that FIG. 24(a) shows an arrangement in which the regulating member 43a is provided. In contrast, FIG. 24(b) shows an arrangement in which the regulating member 43a is not provided. Note also that indicated by respective arrows of FIG. 24(a) and FIG. 24(b) are the self weight-induced flow-in of the developer.

See FIG. 24(a). In the case where the regulating member 43a is not provided, the gravity of the developer causes the developer to directly enter the first recess portion 41 from the discharging opening 43. Therefore, when a good deal of the developer is left in the container main body 31, the developer has a heavy weight. Accordingly, a heavy gravity is imposed on the developer. This causes a large amount of the developer to flow into the first recess portion 41. Further, because the developer is densed by the load of the heavy gravity, the developer per unit volume becomes large, thereby further increasing the amount of the developer flowing into the first recess portion 41. Meanwhile, when the remaining amount of the developer is small in the container main body 31, the developer has a light weight. Accordingly, a light gravity is exerted to the developer. This causes a small amount of the developer to flow into the first recess portion 41. Further, because the developer is less densed, the developer per unit volume becomes small, thereby further decreasing the amount of the developer flowing into the first recess portion 41. As such, in the case where the regulating member 43a is not provided, the developer cannot be stably supplied, thereby making it impossible to evenly form images. This causes qualities of the images to be deteriorated. Further, the developer thus densed by its weight is agglomerated while supplied to the developer section. Accordingly, the developer thus agglomerated is not only coagulated and fused, but also overloads a rotation torque of the image forming apparatus. This possibly damages on a driving system of the image forming apparatus.

On the contrary, in the case where the regulating member 43a is provided as shown in FIG. 24(b), even when the first recess portion 41 is disposed in the vicinity of the bottom dead center, the regulating member 43a diverts the inflow of the developer as indicated by the arrow of FIG. 24(b). On this occasion, a resistant force is exerted against the load of the gravity, thereby preventing the weight of the developer from causing the developer to directly flow into the first recess portion 41 via the discharging opening 43. Specifically, the regulating member 43a ensures that such a discharging direction (i.e., the inflow indicated by the arrow of FIG. 24(b)) that the developer is discharged from the discharging opening 43 when the first recess portion 41 is positioned in the vicinity of the bottom dead center is not integrated with a direction of the gravity on the developer. This prevents weight-induced acceleration of the developer to be supplied to the first recess portion 41. Therefore, the regulating member 43a allows the developer to be always evenly supplied from the developer container 30 to the developing section, irrespective of how much the developer is left in the developer container 60.

The regulating member 43a preferably has such a shape, and is preferably provided in such a location that the discharging direction (the inflow) of the regulating member 43a is orthogonal to the direction of the gravitational force of the developer. Therefore, such a regulating member may be, for example, the regulating member 43a, in accordance with the present embodiment, having a tube-like shape, the regulating member 43b (shown in FIG. 7(b)) having a plate-like shape, or the like. These regulating members can effectively prevent the weight of the developer from causing the developer to be supplied too much to the first recess portion 41.

Further, that side of the discharging opening 43 which is positioned outwardly in the radial direction of the third container portion 35 is connected with that inner peripheral surface of the third container portion 35 which excludes the first and the second recess portions 41 and 42. On this account, even when the remaining amount of the developer is small in the container main body 31, the developer can be easily supplied to the first retention space 62a via the discharging opening 43.

When the container main body 31 further rotates in the rotation direction R from the state shown in FIG. 20(b), the developer of the developer layer 63 in the container main body 31 enters the first retention space 62a via the discharging opening 43, and flows into the downstream of the first retention space 62a. Thereafter, the container main body 31 further rotated to such a position that the discharging opening 43 is above the upper level 63a of the developer layer 63 of the container main body, and that the first retention space 62a is below the upper level 63a, as shown in FIG. 21(a). In this state, a predetermined amount of the developer is kept in the first retention space 62a. The amount of the developer kept in the first retention space 62a is preferably in a range of 50% to 90% of containing volume of the first retention space 62a.

Next, the container main body 31 further rotates, in the rotation direction R, from the position of the FIG. 21(a) to a position shown in FIG. 21(b). On this occasion, the unfixed portion 38b of the leading member 38 of the supporting member 32 enters the first retention space 62a. The unfixed portion 38b elastically abuts, at an angle θ of 90° or greater, against the outer peripheral surface of the bottom wall portion 41b of the first recess portion 41. The unfixed portion 38b slides along the surface of the bottom wall portion 41b. Thereafter, the container main body 31 further rotates in the rotation direction R, thereby flowing the developer toward the supporting member 32, the developer being kept in that portion of the first retention space 62 which is above the leading member 38.

As indicated by an arrow G2 of FIG. 21(b), the leading member 38 leads the developer thus discharged (i.e., the developer discharged from the discharging opening 43 of the container main body 31), along its upper surface, into the through opening 51. Because the leading member 38 slides in such a manner that the leading member 38 scrapes out the developer from the outer peripheral surface of the bottom wall portion 41b, even the last part of the developer that is kept in the first retention space 62a can be sent to the through opening 51. In other words, the leading member 38 leads the developer to the through opening 51 in such an order of from (a) the developer positioned in that downstream portion of the first recess portion 41 which is located in a downstream of the rotation direction R, to (b) the developer positioned in that portions of the first recess portion 41 which are located in an upstream of the rotation direction R. The developer thus led to the through opening 51 is ejected to outside of the developer container 30. As such, each time the container main body 31 rotates, in the rotation direction R, with respect to the rotation axis line L31, a predetermined amount of the developer is discharged to outside.

As described above, in the whole circumference, the inner peripheral surface 48 of the supporting member 32 does not wholly make contact with that portion of the third container portion 35 which excludes the first recess portion 41 and the second recess portion 42. This is for reducing the frictional force against the rotation of the container main body 31 around the rotation axis line L31. For this reason, there is a little possibility that the developer, which is kept in the first retention space 62a as described above, leaks out from the first retention space 62a. To solve the problem, the discharging guides 44 are provided on that outer peripheral surface of the third container portion 35 which excludes the first recess portion 41 and the second recess portion 42. The discharging guides 44 provided in the first end portion of the third container portion 35 inclines, in the rotation direction R, from the first end portion toward the second end portion of the third container portion 35. Also, the discharging guides 44 provided in the second end portion of the third container portion 35 inclines, from the second end portion toward the first end portion of the third container portion 35, with respect to the rotation direction R. On this account, even if the developer that is kept in the first retention space 62a leaks out toward the first and the second end in the axis line L31 while the container main body 31 rotates in the rotation direction R, the developer thus leaked can be gathered, by the discharging guides 44, in the central portions of the third container portion 35 and the supporting member 32.

Further, even if the developer that is kept in the first retention space 62a leaks out from the upstream of the first retention space 62b, the developer thus leaked out, and the developer thus gathered in the central portions by the discharging guide 44 are kept in the second retention space 62b. When the container main body 31 rotates in the rotation direction R, the unfixed portion 38b of the leading member 38 of the supporting member 32 enters the second retention space 62b as shown in FIG. 21(a). The unfixed portion 38b is extended in the upstream direction of the rotation direction R, thereby elastically abutting against the surface of the bottom wall portion 42b of the second recess portion 42 at an angle θ of 90° or greater. The unfixed portion 38b slides, along the outer peripheral surface of the bottom wall portion 42b, from the upstream of the second recess portion 42, in the rotation direction R.

On this occasion, by the rotation of the container main body 31, the developer that is kept in the second retention space 62b is led, along the leading member 38, in the direction of the supporting member 32, to the through opening 51. Then, the developer is discharged to the outside of the developer container 30. As such, the second retention space 62b allows the predetermined amount of the developer to be securely discharged to outside even if the developer leaks out from the first retention space 62a each time the container main body 31 rotates, in the rotation direction R, with respect to the rotation axis line L31.

Further, as described above, the discharging portion 50 protruding in the direction F1 (that is one horizontal direction when the supporting board is placed on a horizontal flat plane) is provided on the upper portion of the supporting member 32. In the central portion of the discharging portion 50, the through opening 51 having an oval shape is formed. The through opening 51 penetrates the discharging portion 50 in the direction F1, and extends parallel to the axis line L32. On this account, even when the container main body 31 is filled up with the developer, the upper level 63a of the developer layer 63 is disposed as high as the through opening 51, or is disposed below the through opening 51. This securely prevents the developer from unintentionally flowing out from the developer container 31 to the through opening 51.

As described above, according to the developer container 30 of the present embodiment, the container main body 31 can rotate around the rotation axis line L31 while the container main body 31 is stably supported by the supporting member 32. In cases where a conventional developer container having a cylindrical shape is placed perpendicularly to a horizontal flat plane for a period of time, developer therein is possibly agglomerated in a lower portion of the conventional developer container. Further, even if the conventional developer container is placed parallel to the horizontal flat plane in order to prevent the agglomeration as much as possible, the conventional developer container rolls. On the contrary, the developer container 30 of the present embodiment is arranged so that, by placing the supporting board 49 of the supporting member 32 on the horizontal flat plane, the container main body 31 can be so disposed that the axis line L31 of the container main body 31 is always parallel to the horizontal flat plane. Further, even if the developer contained in the developer container 30 is partially agglomerated, the developer thus agglomerated can be brought back to the powder form with ease, for example, by manually moving the shutter 65a of the shutter section 65 to the closing position P1, and rotating the container portion 31 to stir the developer, the developer is brought back to the powder form.

Further, the developer container 30 of the present embodiment is arranged so that the regulating member 43a is provided in the discharging opening 43. This prevents the self weight-induced flow-in of the developer into the first recess portion 41, as described above. Therefore, the supply amount of the developer becomes independent from the amount of the developer left in the developer container 30. On this account, the developer can be more stably supplied to the developing section.

Further, the developer container 30 of the present embodiment is arranged so that a discharge amount of the developer depends on the volume of the first retention space 62a, and on a rotation speed of the container main body 31. In the present embodiment, the developer container 30 is arranged so that the discharging opening 43 is provided only in the first recess portion 41 of the first recess portion 41 and the second recess portion 42. However, the present invention is not limited to this. For example, in cases where it is necessary to discharge a larger amount of the developer by each rotation of the container main body 31, the second recess portion 42 may have the same shape as the first recess portion 41, and may include the discharging opening 43 and the regulating member 43a. Further, the developer container 30 may include more recess portions and more discharging openings.

Further, the developer container 30 of the present embodiment is preferably arranged so that the developer (toner) contained in the container main body 31 has a particle diameter of 7 μm or less. An intermolecular force becomes stronger in inverse proportion to the particle diameter of the developer including toner and the like. The developer is possibly agglomerated, and this causes blocking and puncturing with ease. However, even when the developer has a particle diameter of 7 μm or less, i.e., even when the developer becomes easily agglomerated due to the strong intermolecular force, the developer container 30 of the present embodiment ensures that the developer is prevented from being discharged too much to the developing section. On this account, the developer can be prevented from being agglomerated.

The following description explains an image forming apparatus 70 in which the developer container 30 is detachably provided, the image forming apparatus 70 being one example of the present invention.

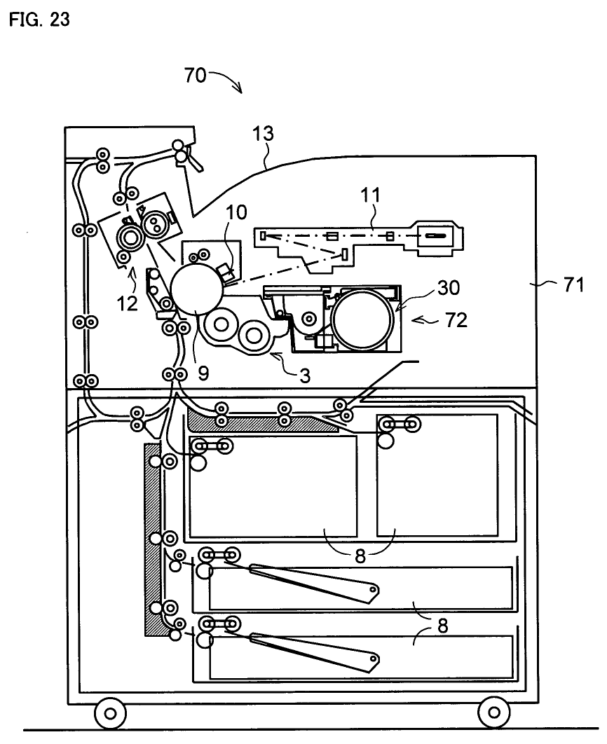

FIG. 23 is a cross sectional view illustrating the image forming apparatus 70. The image forming apparatus 70 is an image forming apparatus of an electro-photographical type such as a printer, photocopier, and the like. The image forming apparatus 70 includes an image forming apparatus main body 71 having the developer container 30. The developer container 30 is detachably provided in a toner hopper 72 of the image forming apparatus main body 71 via a container inlet (not shown) of a front chassis (not shown) of the image forming apparatus main body 71. The container inlet can be arbitrarily opened and closed.

Apart from the developer container 30, the image forming apparatus main body 71 further includes a developing section 3, a sheet cassette 8, and a discharge tray 13. The developing section 3 develops an image with the use of the developer supplied from the toner hopper 72. The sheet cassette 8 contains sheets, on which an image is formed. Further, the developing section 3 includes a photosensitive drum 9, a charging section 10, a laser exposure section 11, a fixing section 12, and the like. The photosensitive drum 9 is a cylindrical drum having a photoreceptor on its outer peripheral surface, and rotates with respect to its axis line. The charging section 10 electrifies the photoreceptor of the photosensitive drum 9 so as to give photosensitivity to the photoreceptor. By using a laser beam, the laser exposure section 11 exposes the photoreceptor of the photosensitive drum 9 which has been charged. Hereby, the laser exposure section 11 forms an electrostatic latent image on the photoreceptor. The fixing section 12 fixes a toner image, which has been transferred onto a sheet.

The developing section 3 stirs the developer supplied from the toner hopper 73, and supplies the developer to the photosensitive drum 9, on which the electrostatic latent image is formed, so as to develop the image. In this way, a toner image that corresponds to the electrostatic latent image is formed. The photosensitive drum 9 transfers the toner image, which is formed on the photosensitive drum 9, to the sheet supplied from the sheet cassette 11. The sheet on which the toner image is formed is delivered to the discharge tray 13. Note that, except the toner hopper 72, the image forming apparatus has the same structure to a well-known conventional image forming apparatus.

According to the image forming apparatus 70, the developer is stably supplied, to the developing section from the developer container 30, irrespective of how much the developer is left in the developer container 30. This prevents blocking and puncturing caused by the agglomeration of the developer, thereby improving an image quality.

Further, the developer container of the present invention is arranged so that the recess portion includes a terminal wall on its downstream end which is one end associated with the downstream of the rotation direction, the terminal wall having a surface orthogonal to the rotation direction, the discharging opening being formed on the terminal wall.

According to the arrangement, even when the remaining amount of the developer is small in the container main body, the developer is securely discharged into the discharging opening. Therefore, even when the remaining amount of the developer is small, an amount of the developer to be supplied does not change. On this account, the developer can always be stably supplied.

The developer container of the present invention is preferably arranged so that the regulating member is so provided on the terminal wall that the regulating member is perpendicular to the terminal wall.

According to the arrangement, the inflow of the developer (i.e., such a direction that the developer is discharged from the discharging opening when the recess portion is disposed in the vicinity of the bottom dead center) is not integrated with a direction of the gravitational force exerted to the developer. This prevents preventing the weight of the developer from causing the developer to directly flow into the first recess portion 41. On this account, the developer can be always evenly supplied from the developer container to the developing section, irrespective of how much the developer is left in the developer container.

The developer container of the present invention is arranged so that the supporting means includes leading means (leading member) in its inner peripheral surface, the leading means leading, to the through opening, the developer discharged from the discharging opening of the container main body.

According to the arrangement, the developer discharged into the recess portion can be led to the through opening. Further, the arrangement prevents the developer from being supplied too much to the developing section. On this account, the developer is prevented from being agglomerated, and from accordingly causing blocking while the developer is sent to the developing section.

The developer container of the present invention is preferably arranged so that the leading means (leading member) leads the developer to the through opening in such an order of from (a) the developer positioned in that downstream portion of the recess portion which is located in a downstream of the rotation direction, to (b) the developer positioned in that portions of the recess portion which are located in an upstream of the rotation direction.

The developer container of the present invention is preferably arranged so that the developer contained in the container main body has a particle diameter of 7 μm or less.

The developer container of the present invention is preferably arranged so that the recess portion and the discharging opening are formed on a substantially central portion of the axis line. According to this arrangement, by rotating the container main body, the developer contained in a portion which is associated with the first end portion of the container main body, and the developer contained in a portion which is associated with the second end portion of the container main body collide each other in the vicinity of the discharging opening of the container main body, the first and the second ends being with respect to the axis line. If the developer container is arranged so that the developer is supplied to the first end portion of the container main body, the developer to be supplied is possibly agglomerated by pressure exerted from an inner wall perpendicular to an axis line of the first end portion of the developer container.

The present invention ensures that the developer contained in the portion which is associated with the first end of the container main body, and the developer contained in the portion which is associated with the second end of the container main body can collide each other in the vicinity of the discharging opening of the container main body, i.e., in the substantially central portion of the container main body. This stirs the developer. On this account, even if the developer contained in the developer container is agglomerated, the rotation of the container main body makes it possible to bring the developer back to the powder form by stirring it.

Further, the developer container of the present invention is preferably arranged so that the regulating member has a tube-like shape.

The developer container of the present invention is preferably arranged so that the container main body is manufactured by carrying out a blow forming.

The developer container of the present invention is arranged so that, the container main body has a second recess portion on the outer peripheral surface thereof, the second recess portion being located oppositely to the recess portion with respect to the axis line. According to this arrangement, even when a remaining amount of the developer is small, the recess portion and the second recess portion ensure that the developer can be effectively gathered in the vicinity of the discharging opening of the container main body. This prevents supply amount of the developer from decreasing. On this account, images can be prevented from being unevenly developed.

The developer container of the present invention is preferably arranged so that (1) the container main body including (i) a first container portion that has a cylindrical shape having a bottom; (ii) a second container portion that has a cylindrical shape having a bottom; and (iii) a third container portion that has a cylindrical shape, and that includes the recess portions and the discharging opening; and (2) the container main body is so manufactured in one piece that a first end portion of the third container portion is connected to an aperture end portion of the first container portion, and that a second end portion of the third container portion is connected to an aperture end portion of the second container portion, the first end portion being an end portion in the axis line, and the second end portion being the other end portion in the axis line.

According to the arrangement, it is possible to realize the container main body, (i) in which the recess portion and the discharging opening are formed in the central portion of the axis line of the container main body, and (ii) whose end portions in the axis line are closed. Further, it is possible to manufacture, in one piece, the container main body including the first, the second, and the third container portions by carrying out, for example, a blow forming.

Further, the developer container of the present invention is preferably arranged so that a material of the leading means (leading member) is a polymer resin, and has a sheet-like shape.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. A developer container, comprising:
a container main body, configured to be detachably provided in an image forming apparatus, and to contain a developer for use in image formation, the container main body having a cylindrical shape; and
a supporting member which supports the container main body in such a manner that the container main body is freely rotatable,
wherein:
the container main body has a recess portion on its outer peripheral surface, the recess portion being inwardly depressed in a radial direction of the container main body, having a discharging opening so as to discharge the developer in a downstream of a rotation direction in which the container main body rotates around an axis line of the container main body;
the developer contained in the container main body is sent to the discharging opening by rotating the container main body around the axis line;
the supporting member supports the container main body by wholly covering at least that portion of the container main body which includes the recess portion of the container main body in such a manner that the container main body is freely rotatable with respect to the axis line;
the container main body includes a through opening for leading the developer to an outside of the container main body, the developer being discharged from the discharging opening; and
a regulating member for regulating a discharging amount of the developer is provided, substantially along the rotation direction of the container main body, on that surface of the recess portion which the discharging opening is provided.

2. The developer container as set forth in claim 1, wherein:
the recess portion includes a terminal wall on its downstream end which is one end associated with the downstream of the rotation direction, the terminal wall having a surface orthogonal to the rotation direction, the discharging opening being formed on the terminal wall.

3. The developer container as set forth in claim 2, wherein:
the regulating member is so provided on the terminal wall that the regulating member is perpendicular to the terminal wall.

4. The developer container as set forth in claim 1, wherein:
the supporting means includes leading means in its inner peripheral surface, the leading means leading, to the through opening, the developer discharged from the discharging opening of the container main body.

5. The developer container as set forth in claim 4, wherein:
the leading means leads the developer to the through opening in such an order of from (a) the developer positioned in that downstream portion of the recess portion which is located in a downstream of the rotation direction, to (b) the developer positioned in that portions of the recess portion which are located in an upstream of the rotation direction.

6. The developer container as set forth in claim 1, wherein:
the developer contained in the container main body has a particle diameter of 7 μm or less.

7. The developer container as set forth in claim 1, wherein:
the recess portion and the discharging opening are located on a substantially central portion along the axis line.

8. The developer container as set forth in claim 1, wherein:
the regulating member has a tube-like shape.

9. The developer container as set forth in claim 8, wherein:
the container main body is manufactured by carrying out a blow forming.

10. The developer container as set forth in claim 1, wherein:
the container main body has a second recess portion on the outer peripheral surface thereof, the second recess portion being located oppositely to the recess portion with respect to the axis line.

11. The developer container as set forth in claim 1, wherein:
the container main body includes:
a first container portion that has a cylindrical shape having a bottom;
a second container portion that has a cylindrical shape having a bottom; and
a third container portion that has a cylindrical shape, and that includes the recess portions and the discharging opening; and
the container main body is so manufactured in one piece that a first end portion of the third container portion is connected to an aperture end portion of the first container portion, and that a second end portion of the third container portion is connected to an aperture end portion of the second container portion, the first end portion being an end portion in the axis line, and the second end portion being the other end portion in the axis line.

12. The developer container as set forth in claim 4, wherein:
a material of the leading means is a polymer resin, and the leading means has a sheet-like shape.

13. An image forming apparatus, comprising:
a developer container, configured to be detachably provided to contain a developer for use in an image formation; and
a developing section for developing an image with the use of the developer supplied from the developer container,
wherein:
the developer container of the present invention includes: (1) a container main body, configured to contain a developer for use in image formation, the container main body having a cylindrical shape; and (2) a supporting member which supports the container main body in such a manner that the container main body is freely rotatable;
the container main body has a recess, portion on its outer peripheral surface, the recess portion being inwardly depressed in a radial direction of the container main body, having a discharging opening so as to discharge the developer in a downstream of a rotation direction in which the container main body rotates around an axis line of the container main body;
the developer contained in the container main body is sent to the discharging opening by rotating the container main body around the axis line;
the supporting member supports the container main body by wholly covering at least that portion of the container main body which includes the recess portion of the container main body in such a manner that the container main body is freely rotatable with respect to the axis line;
the container main body includes a through opening for leading the developer to an outside of the container main body, the developer being discharged from the discharging opening; and
a regulating member for regulating a discharging amount of the developer is provided, substantially along the rotation direction of the container main body, on that surface of the recess portion which the discharging opening is provided.
